(19) United States
(12) Patent Application Publication
(10) Pub. No.: US 2018/0247343 A1
(43) Pub. Date: Aug. 30, 2018

(54) BILLBOARD INSTALLATION DATA GENERATION AND TRANSMISSION PROGRAM, INFORMATION PROCESSING COMMUNICATION TERMINAL FOR EXECUTING THE BILLBOARD INSTALLATION DATA GENERATION AND TRANSMISSION PROGRAM, AND INFORMATION PROCESSING COMMUNICATION SERVER

(71) Applicant: Tosen AD Co., Ltd., Tokyo (JP)

(72) Inventor: Yuzuru Higashi, Tokyo (JP)

(73) Assignee: Tosen AD Co., Ltd., Tokyo (JP)

(21) Appl. No.: 15/832,107

(22) Filed: Dec. 5, 2017

(30) Foreign Application Priority Data
Feb. 28, 2017 (JP) 2017-36822

(51) Int. Cl. G06Q 30/02; G09F 19/22; H04N 1/00; G06F 17/30; G06T 19/00; G06F 3/0488

(52) U.S. Cl. CPC G06Q 30/0276; G09F 19/228; G06F 3/0488; G06F 17/30241; G06T 19/006; H04N 1/00307

(57) ABSTRACT

A CPU11 of an information processing communication terminal 1 executes a billboard installation data generation and transmission application 16a2 to store photo data of a place where the billboard photographed by the camera 12 is stored in a storage unit 13 11a and a photo data display control means 11b for causing a touch panel type display unit 15 to display photo data stored in the storage unit 13, the silhouette image generating/synthesizing means 11c for synthesizing and displaying billboard image data which is image data of the billboard on photo data displayed on the touch panel type display unit 15, and photo data displayed on the touch panel type display unit 15 and billboard installation data transmission control means 11d which causes data including at least billboard image data, billboard installation data, to be transmitted from the data communication unit 14.

### BACKGROUND OF THE INVENTION

### Field of the Invention

The present patent application corresponds to Japanese Patent Application No. 2017-36822 filed Feb. 28, 2017, and relates to a billboard installation data generation and transmission program for executing an information processing communication terminal including at least a camera, a data communication unit for transmitting and receiving data, and a display unit; an information processing communication terminal for executing the billboard installation data generation and transmission program; and an information processing communication server.

### Description of the Related Art

There has been proposed an advertisement media rental system for outdoor advertisement, which uses a conventional information processing communication terminal that displays, for example, a plurality of advertisement media of outdoor advertisement in a virtual townscape on a computer by changing display method depending on the situation, and stores general information such as size, fee, vacancy period and application deadline for each of the advertisement media, or media specific information including bid/successful bid date and application method, and so on, so that the user who is a borrower presents the member number, scrolls the virtual street displayed on the borrower side terminal, reads out the general information based on information on the desired advertisement medium, and makes an application or bid, and then, the lender side notifies the borrower of the application result or the bidding result after a predetermined procedure.

(For example, see Patent Document 1).

### PRIOR ART DOCUMENT

### Patent Literature

Patent Literature 1: Japanese Unexamined Patent Application Publication No. 2001-312646

### SUMMARY OF THE INVENTION

### Problem to be Solved by the Invention

However, in the above-mentioned information processing communication terminal disclosed in Patent Literature 1, a plurality of advertisement media for outdoor advertisement were displayed in virtual townscapes on a computer while changing the display method depending on the situation, so that from the viewpoint of the user who is a borrower, the outdoor advertisement was merely displayed in the virtual townscape, and there was a problem that it was impossible to check the image of the real street of the billboard installation place.

Therefore, even if the user who was a borrower liked an outdoor advertisement in the virtual city displayed on the computer, it was necessary to check the real street of the billboard installation place before actually contracting, and it took time and effort to sign a rental agreement for the billboard installation place.

In addition, recent information processing communication terminals such as smart phones have a camera function in addition to the communication function, so it is possible to easily shoot the place of installation of the billboard and send it, but the size of the billboard and billboard installation status could not be sent.

Therefore, the object of the invention is to provide a billboard installation data generation and transmission program that allows the user to easily and surely confirm the state of the actual billboard installation place and the state of the billboard installed at the billboard installation place, and the information processing communication terminal that executes the billboard installation data generation and transmission program, and an information processing communication server.

### Means for Solving the Problem

In order to solve the above problems, the billboard installation data generation and transmission program according to the present invention is firstly characterized in that an information processing communication terminal provided with at least a camera, a data communication unit for transmitting and receiving data, and a display unit, is executed,

as a photo data storage control means for storing photo data of billboard installation places photographed by the camera in a data storage area,
as a photo data display control means for displaying the photo data stored in the data storage area on the display unit, as a silhouette image generation/combination/display control means for generating, on a piece of photo data displayed on the display unit, a board surface silhouette image which is a silhouette image of the board surface of the billboard which does not carry the advertisement content to be carried thereon, and combining the above-mentioned board surface silhouette image with said piece of photo data, thereby to display the combined image, and
as a billboard installation data transmission control means for transmitting, from the above-mentioned data communication unit, a piece of billboard installation data including at least said piece of photo data and said board surface silhouette image displayed on the display unit.

The billboard installation data generation and transmission program according to the present invention is secondarily characterized in that the display unit of the information processing communication terminal is a touch panel type display unit, and the silhouette image generating and synthesizing display control means is such that the user touches a contour point of the billboard on said piece of photo data displayed on the display unit, thereby generating the board surface silhouette image, superimposing the board surface silhouette image on said piece of photo data, and displaying the superimposed on the display unit.

The billboard installation data generation and transmission program according to the present invention is thirdly characterized in that the silhouette image generating and synthesizing display control means is such that when generating the board surface silhouette image, a set of legs silhouette image that is a silhouette image of leg portions of a billboard is added to the board surface silhouette image, and the combination thereof is superimposed on said piece of photo data displayed on the display unit so that the whole thereof is displayed on the display unit.

The billboard installation data generation and transmission program according to the present invention is fourthly characterized in that the silhouette image generating and synthesizing display control means is further such that when generating the board surface silhouette image on said piece of photo data displayed on the display unit, square-shaped grid lines are superimposed at a reference predetermined pitch, and displayed on the display unit.

The billboard installation data generation and transmission program according to the present invention is fifthly characterized in that the silhouette image generation/combination/display control means performs control so that when generating the board surface silhouette image on said piece of photo data displayed on the display unit, combining the board surface silhouette image with said piece of photo data and then displaying the combined image, if a plurality of photo data are being stored in the data storage area, the board surface silhouette image generated with one of the photo data is saved, and the saved board surface silhouette image is read out, reduced or enlarged and attached on another piece of photo data, thereby displaying the board surface silhouette image on said piece of photo data in a combined manner.

The billboard installation data generation and transmission program according to the present invention is sixthly characterized in that the photo data storage control means performs control such that when storing photo data of billboard installation places photographed by the camera in the data storage area without storing a plurality of photo data obtained by photographing each billboard installation place at different distances, it is impossible to proceed to the process of displaying the photo data stored in the data storage area on the display unit by using the photo data display control means.

Further, the information processing communication terminal according to the present invention is characterized by executing any one of the above-mentioned billboard installation data generation and transmission programs.

Furthermore, an information processing communication server according to the present invention is characterized by comprising: a data receiving means for receiving the billboard installation data received from the information processing communication terminal that executes the billboard installation data generation and transmission program according to claim 7; and a billboard installation service provision means that provides a billboard installation service based on the billboard installation data in such a manner that a plurality of billboard installation data received by the data receiving means are displayed, and simultaneously a billboard installation data selection screen that allows the user to make a selection from among the displayed plurality of billboard installation data, is generated and displayed on its own information processing communication terminal or the user's information processing communication terminal.

### Effect of the Invention

In the billboard installation data generation and transmission program, the information processing communication terminal for executing the billboard installation data generation and transmission program, and the information processing communication server according to the present invention, the information processing communication terminal generates board surface silhouette images which are silhouette images of the board surfaces of the billboards which do not carry the advertisement content to be carried thereon, combines each of the board surface silhouette images with the respective piece of photo data photographed by a camera, and displays the combinations thereof, and simultaneously transmits, to the information processing communication server, the billboard installation data each including at least the board surface silhouette image combined with the respective piece of photo data; and then the information processing communication server receives the billboard installation data, and displays them, and simultaneously generates a billboard installation data selection screen that allows the user to make a selection from among the displayed plurality of billboard installation data, so that the billboard installation data selection screen is displayed on its own information processing communication terminal or the user's information communication terminal.

Therefore, in the information processing communication server or the user's information processing communication terminal, the photographed photographic data each have at least the board surface silhouette image combined therewith, so the state of the actual billboard installation place and the state of the billboard installed at the billboard installation place can be checked on the screen easily and reliably.

### BRIEF DESCRIPTION OF THE DRAWINGS

FIG. 1 is a block diagram showing the configuration and connection of the information processing communication terminal and the information processing communication server according to an embodiment of the present invention.

FIG. 2 is a flowchart showing billboard installation data generation and transmission processing which is performed by the information processing communication terminal executing a billboard installation data generation transmission program according to an embodiment of the present invention.

FIG. 3A and FIG. 3B respectively show just examples of an initial screen or an application selection screen and an example of the top screen of the billboard installation data generation transmission application, displayed on the touch panel type display unit of the information processing communication terminal according to an embodiment of the present invention.

FIG. 4 is a flowchart showing a detailed processing procedure of the photographing process in step S200 shown in FIG. 2.

FIG. 5A to FIG. 5C show just a set of examples of a photograph shooting screen, a photograph decision screen, and a saving confirmation screen, respectively, displayed on the touch panel type display unit when performing the photograph shooting process by using an information processing communication terminal according to an embodiment of the present invention.

FIG. 6 is a flowchart showing a detailed processing procedure of the first half of the silhouette creation processing in the silhouette creation processing of step S300 shown in FIG. 2.

FIG. 7A to FIG. 7D respectively show just examples of a photo folder selection screen, a photo data selection screen, a selected photograph determination screen, and a screen silhouette creation explanation screen, displayed on the touch panel type display unit when performing the board surface silhouette creation processing by using an information processing communication terminal according to an embodiment of the present invention.

FIG. 8 is a diagram showing an example of the silhouette creation screen displayed on the touch panel type display unit when performing a billboard surface silhouette creation processing by using an information processing communication terminal according to an embodiment of the present invention.

FIG. 9 is a diagram showing an example of the silhouette creation screen displayed on the touch panel type display unit in performing a billboard surface silhouette creation processing by using an information processing communication terminal according to an embodiment of the present invention.

FIG. 10 is a diagram showing an example of the silhouette creation screen displayed on the touch panel type display unit in performing a billboard surface silhouette creation processing by using an information processing communication terminal according to an embodiment of the present invention.

FIG. 11A to FIG. 11D respectively show just examples of a silhouette creation screen and a billboard surface silhouette completion screen, displayed on the touch panel type display unit in performing a board surface silhouette creation processing by using an information processing communication terminal according to an embodiment of the present invention.

FIG. 12 is a flowchart showing a detailed processing procedure of the second-half of a set of legs silhouette creation processing in the silhouette creation processing shown in FIG. 2.

FIG. 13A and FIG. 13B show examples of a legs-silhouette creation explanation screen and a legs-silhouette creation initial screen respectively displayed on the touch panel type display unit in performing a leg silhouette creation process by using an information processing communication terminal according to an embodiment of the present invention.

FIG. 14 shows just an example of a legs-silhouette creation explanation screen and a legs-silhouette creation initial screen respectively displayed on the touch panel type display unit in performing a legs-silhouette creation process by using an information processing communication terminal according to an embodiment of the present invention.

FIG. 15 shows just an example of a legs-silhouette creation explanation screen and a legs-silhouette creation initial screen respectively displayed on the touch panel type display unit in performing a legs-silhouette creation process by using an information processing communication terminal according to an embodiment of the present invention.

FIG. 16A to FIG. 16D show examples of a billboard silhouette completion screen, a billboard silhouette copy completion screen, a billboard silhouette storage completion screen, and a billboard silhouette complete storage screen respectively displayed on the touch panel type display unit in performing a legs silhouette creation process by using an information processing communication terminal according to an embodiment of the present invention.

FIG. 17A to FIG. 17D show examples of a photo selection screen, the selected photo decision screen, the silhouette creation screen, and the example of the pasting confirmation screen respectively displayed on the touch panel type display unit in performing a legs-silhouette creation process by using an information processing communication terminal according to an embodiment of the present invention.

FIG. 18A to FIG. 18C show examples of a pasting completion screen displayed on the touch panel type display unit in performing a legs-silhouette creation process by using an information processing communication terminal according to an embodiment of the present invention.

FIG. 19A and FIG. 19B show examples of a billboard silhouette complete screen and a billboard silhouette storage completion screen displayed on the touch panel type display unit in performing a legs-silhouette creation process by using an information processing communication terminal according to an embodiment of the present invention.

FIG. 20 is a flowchart showing a detailed processing procedure of the position information setting/mail transmission processing shown in FIG. 2.

FIG. 21A to FIG. 21C respectively show examples of a position information setting explanation screen and a position information setting screen displayed on the touch panel type display unit in the position information setting/mail sending process of the information processing communication terminal of the embodiment.

FIG. 22A to FIG. 22C respectively show examples of a position information setting screen, a billboard installation data folder selection screen and a billboard installation data selection screen, displayed on the touch panel type display unit in performing a position information setting/mail sending process of the information processing communication terminal according to an embodiment of the present invention.

FIG. 23A to FIG. 23C respectively show examples of a temporary file deletion confirmation screen and a temporary file deletion execution screen displayed on the touch panel type display unit in performing a position information setting/mail sending process of the information processing communication terminal according to an embodiment of the present invention.

FIG. 24A to FIG. 24C are diagrams showing examples of a mail creation screen and a mail transmission completion screen displayed on the touch panel type display unit in performing a position information setting/mail transmission processing of the information processing communication terminal according to an embodiment of the present invention.

### DESCRIPTION OF THE PREFERRED EMBODIMENTS

Hereinafter, with reference to the drawings, a billboard installation data generation and transmission program, an information processing communication terminal 1 that execute the billboard installation data generation and transmission program, and an information processing communication server 2 according to an embodiment of the present invention will be described in details. It should be understood that the embodiments described below are merely examples of the present invention, and the present invention is not limited to the following embodiments and can be appropriately changed within the technical idea of the present invention.

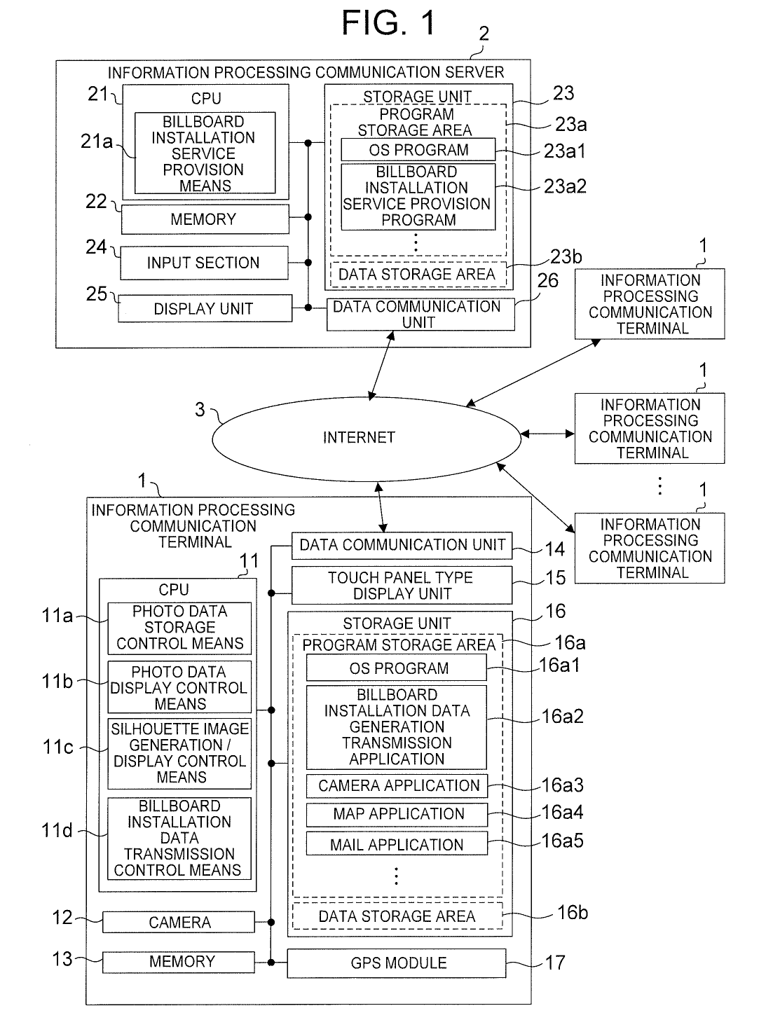

FIG. 1 is a block diagram showing the configuration and connection of the information processing communication terminal 1 and the information processing communication server 2 according to an embodiment of the present invention.

As shown in FIG. 1, the information processing communication terminal 1 according to an embodiment of the present invention is configured to be connected to the information processing communication server 2 via the Internet 3.

### (Configuration of Information Processing Communication Terminal 1)

The information processing communication terminal 1 is an information processing communication terminal having a wireless or wired communication function such as a so-called smartphone, mobile phone, tablet, personal computer, and the like, and a photographing function, and the like, and includes a CPU11, a camera 12, a data communication unit 14, a touch panel type display unit 15, a storage unit 16, a GPS module 17, and the like. Incidentally, the memory 13 and the storage unit 16 may be constituted by the same memory.

Under execution of an operation program 16a stored in the storage unit 16, the CPU11 is configured to control the entire apparatus and executes various application programs (hereinafter may be abbreviated as applications), and is especially configured to achieve functions of various applications of, particularly, when the CPU11 executes the billboard installation data generation and transmission program 16a2 according to the present invention, as will be described later, the photo data storage control means 11a, the photo data display control means 11b, the silhouette image generation combined display control means 11c, and billboard installation data transmission control means 11d.

Like digital cameras, etc., the camera 12 includes an image pickup element such as a CCD or CMOS sensor, and outputs image data such as photographed photo data as digital data.

The memory 13 is composed of a RAM, etc., temporarily holds data processed by the CPU11, and stores image data photographed by the camera 12, etc.

The data communication unit 14 is connected to another information processing communication terminal 1 or the like via the Internet 3 by wireless communication such as high-speed communication using a telephone line such as wireless LAN or LTE communication, wired communication such as optical communication, ADSL or the like and transmits and receives data to and from the information processing communication server 2 and the like.

The touch panel type display unit 15 displays data processed by the CPU11, image data captured by the camera 12, data received via the Internet 3, and the like, and when the user touches with a finger, data and instructions can be entered.

The storage unit 16 is composed of a flash memory such as eMCC or SSD, a hard disk, or the like, and has the program storage area 16a and the data storage area 16b.

In the program storage area 16a, in addition to the operation system (OS) program 16a1 of the information processing communication terminal 1, the billboard installation data generation and transmission application 16a2 which is the billboard installation data generation and transmission program according to this invention, the camera application 16a3, the map application 16a4, the mail application 16a5, and the like are stored.

In the data storage area 16b, various data received by the information processing communication terminal 1 and received through the Internet 3 are stored, and also the photograph data of the installation place of the billboard photographed by the camera 12 is stored.

Note that the program storage area 16a and the data storage area 16b are not necessarily provided in one storage unit 16 but may be provided in different storage units 16. For example, the data storage area 16b stores this information. It may be provided in a storage section such as a flash memory detachable from the processing communication terminal 1 or may be provided in a cloud server (not shown), etc., via the Internet 3.

The GPS module 17 generates GPS position data indicating the current position of the information processing communication server 2 based on radio waves from GPS satellites.

### (Configuration of Information Processing Communication Server 2)

The information processing communication server 2 is a computer device having the wireless or wired communication function such as so-called personal computer and includes the CPU21, the memory 22 such as a RAM, the storage unit 23 such as a hard disk, The input unit 24 such as a keyboard and a mouse, the display unit 25 such as a liquid crystal display, the data communication unit 26 communicating with the information processing communication terminal 1 which is another device via the Internet 3, etc.

The storage unit 23 is provided with a program storage area 23a and a data storage area 23b, and the program storage area 23a stores the operation system (OS) program 23a1 of the information processing communication server 2 and information processing. The communication terminal 1 receives the billboard installation data transmitted by executing the billboard installation data generation and transmission program 16a2 according to this invention and the CPU21 of the information processing communication server 2 displays the billboard installation data on the display unit 25. The billboard installation service provider which is an application program to function as a billboard installation service providing means 21a for providing users with services such as rental of billboards by allowing users to browse billboard setting data program 23a2 is stored.

### <Operations of Information Processing Communication Terminal 1 and Information Processing Communication Server 2 of the Embodiment>

Next, operations of the information processing communication terminal 1 and the information processing communication server 2 configured as described above will be described with reference to the drawings.

### <Operation of Information Processing Communication Terminal 1 Side>

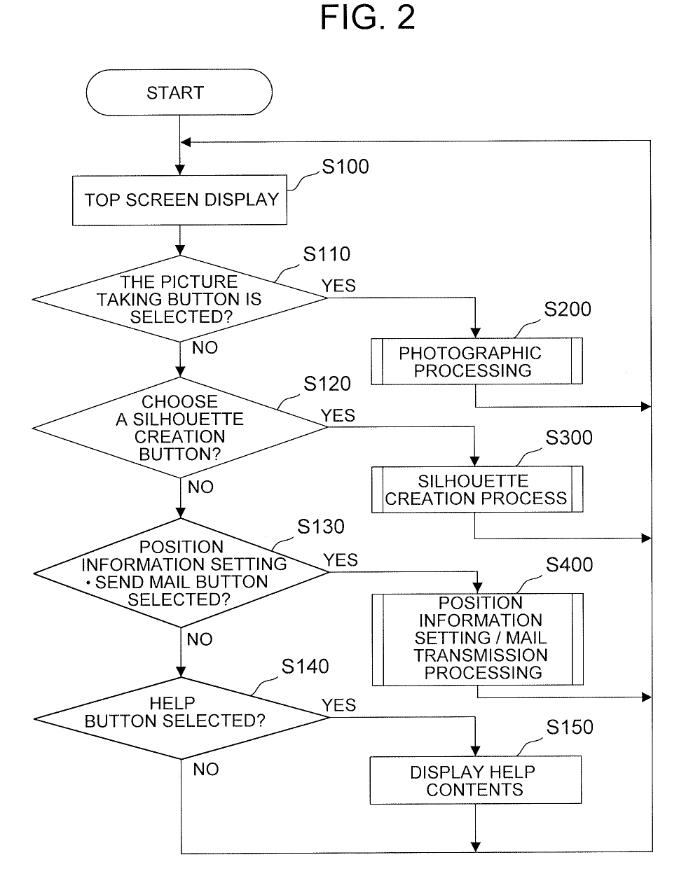

FIG. 2 is a flowchart showing the billboard installation data generation and transmission process processed by the information processing communication terminal 1 according to the embodiment by executing the billboard installation data generation transmission application 16a2.

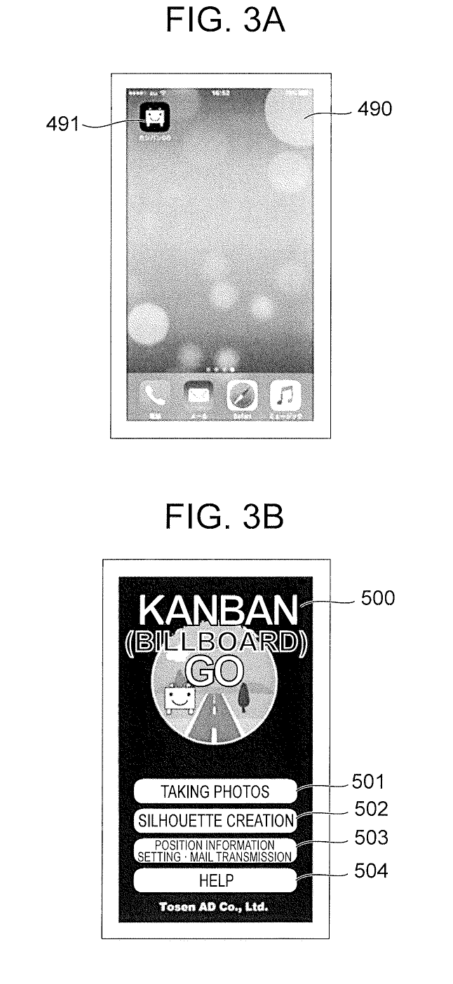

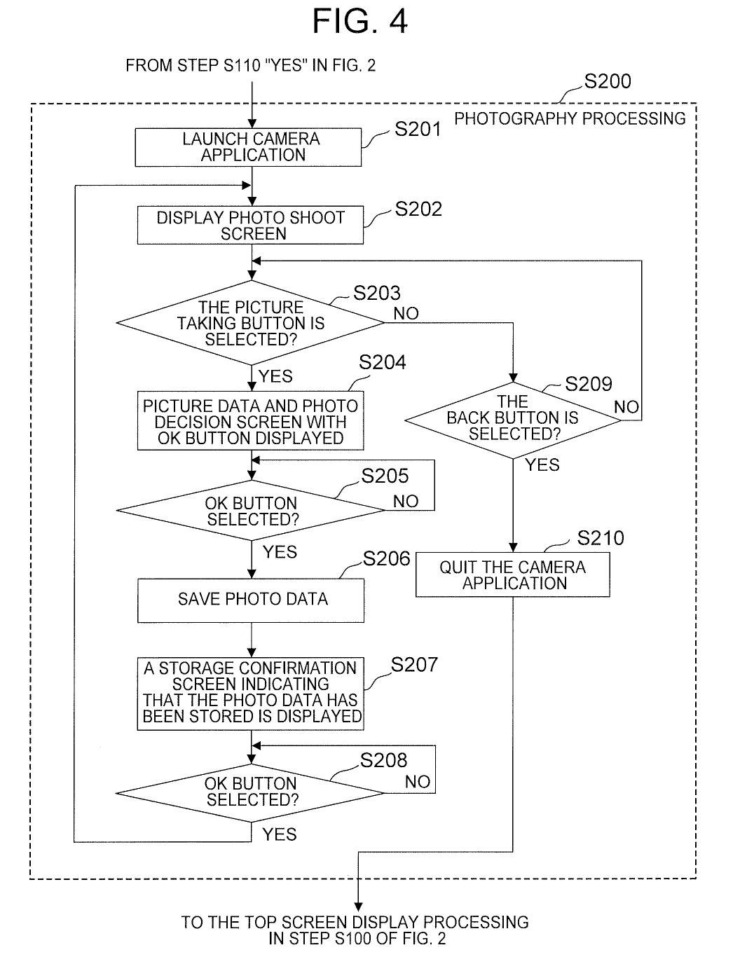

As shown in FIG. 2, when the user turns on the information processing communication terminal 1 and displays on the initial screen or application selection screen 490 as shown in FIG. 3 (a) displayed on the touch panel type display unit 15, when the icons 491 of the billboard installation data generation and transmission application 16a2 are tapped and executed (step S 100 YES), the CPU11 executes the billboard installation data generation and transmission application 16a2 stored in the storage unit 16, the TOP screen 500 of the billboard installation data generation and transmission application 16a2 as shown in FIG. 4B is displayed on the touch panel type display unit 15 (step S110).

On the TOP screen 500 shown in FIG. 3B, for example, a photograph shooting button 501 for shifting to photograph shooting processing, the silhouette creation button 502 for shifting to a silhouette creation processing, the position information setting, in addition to the position information setting/mail transmission button 503 for shifting to mail transmission processing, a help button 504 for displaying help contents when the user is in trouble, and the like are displayed.

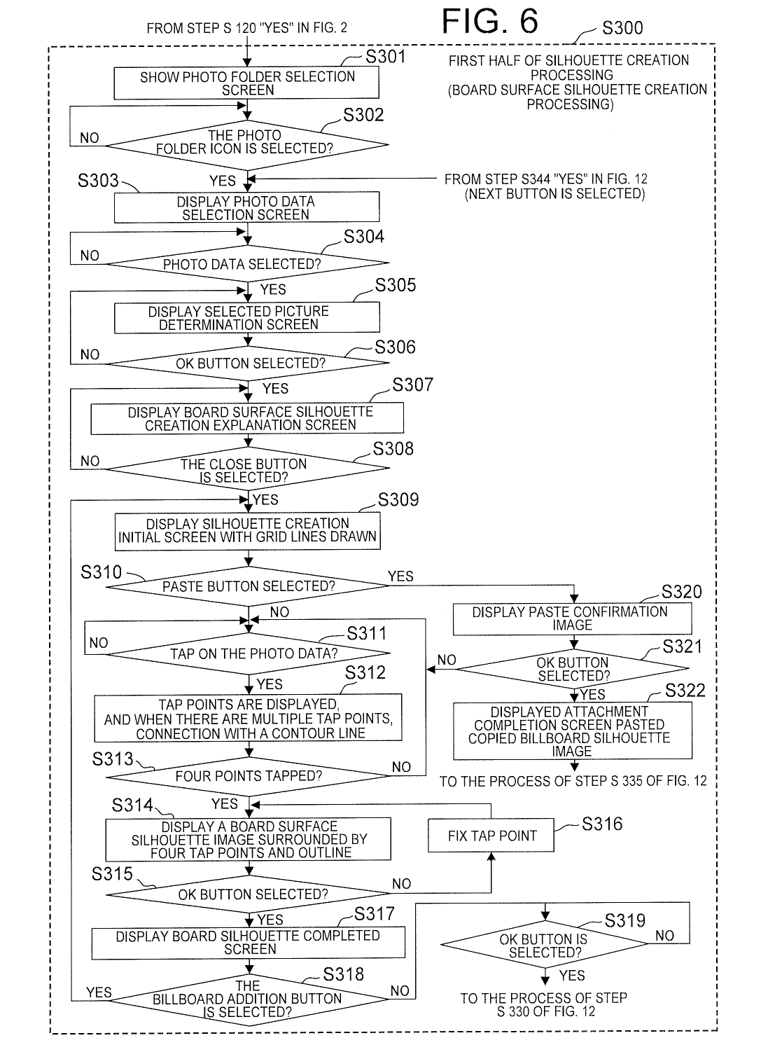

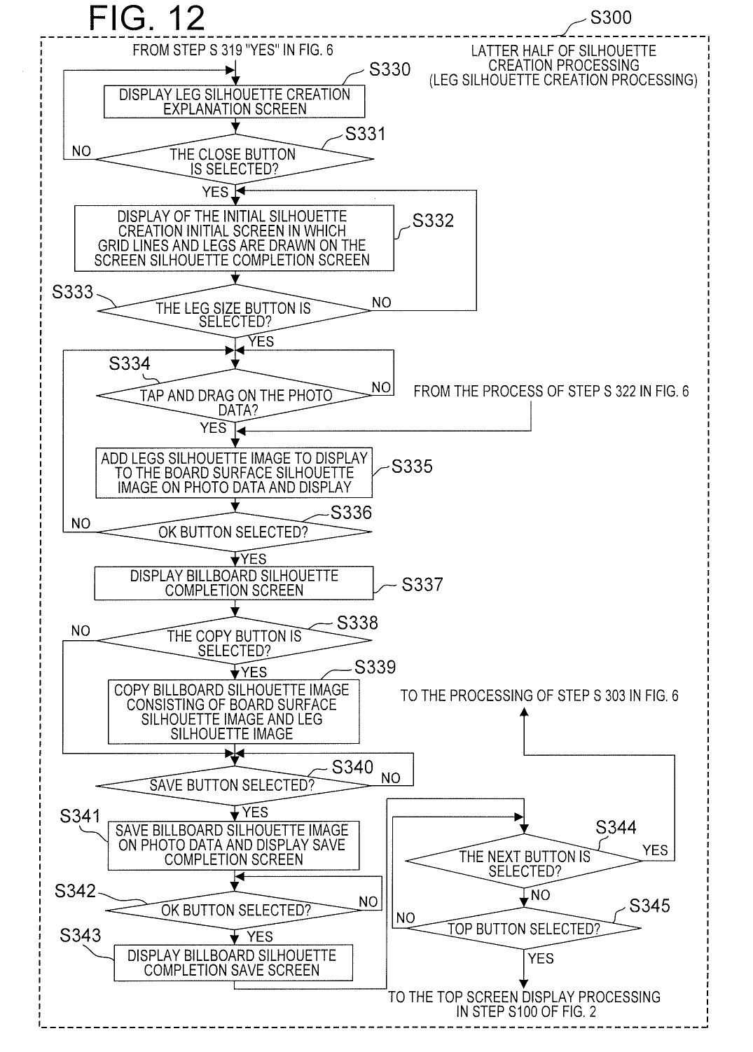

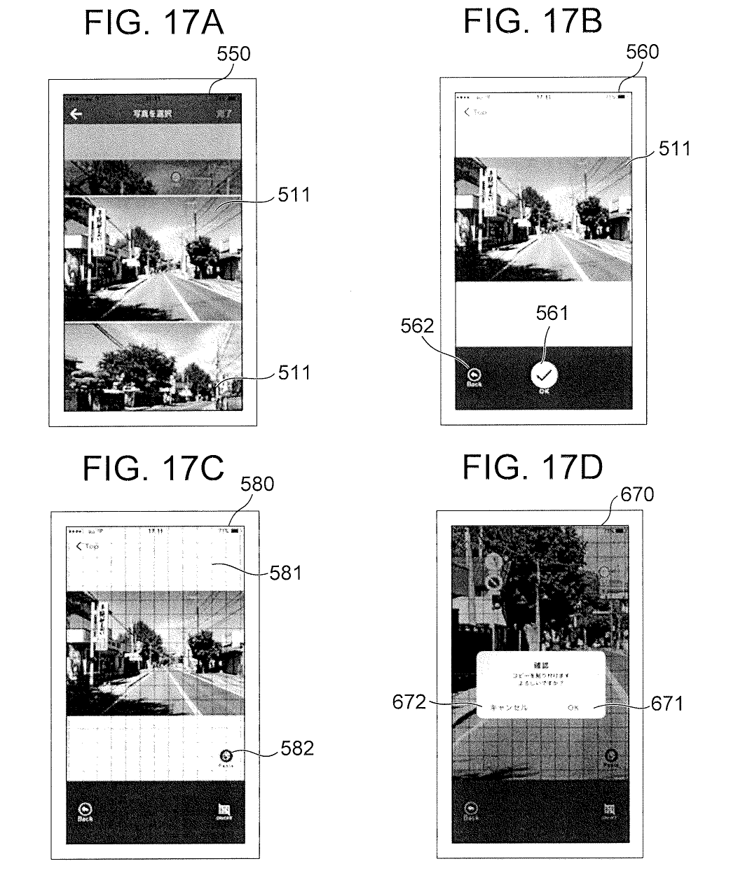

When the user selects the photograph shooting button 501 or the like on the TOP screen 500 shown in FIG. 3B (step S110 YES), the CPU11 executes the billboard installation data generation and transmission application 16a2 (Step S200). When the user selects the silhouette creation button 502 by tapping (step S120 YES), the CPU11 executes the photograph shooting process shown in FIGS. 6 and 12 (Step S300). When the position information setting/mail transmission button 503 is selected by tapping etc. (step S130 YES), detailed processing is performed in FIG. 17 described later, the position information setting/mail transmission indicating the procedure is executed (step S400).

When the user selects the help button 504 on the TOP screen 500 shown in FIG. 3B (YES in step S140), the help content of the billboard installation data generation and transmission application 16a2 created in advance is transmitted to the touch panel type display unit 15 (Step S150).

### (1) Photographing Process.

Next, the photographing process in Step S200 shown in FIG. 2 will be described in detail.

FIG. 4 is a flowchart showing the detailed processing procedure of the photographing process in step S200 shown in FIG. 2.

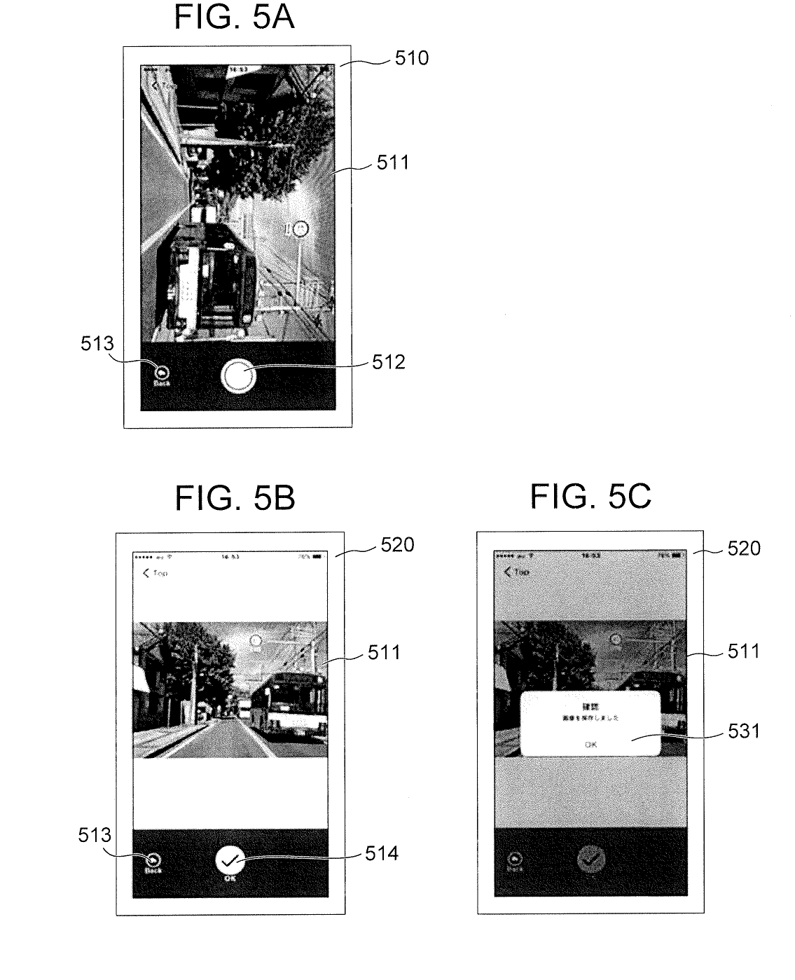

When the user selects the photograph shooting button 501 by tapping on the TOP screen 500 shown in FIG. 3B (YES in step S 110), the CPU11 first activates the camera application 16a3 (step S201), as shown in FIG. 5A, the photograph data 511 shot by the camera 12, the photograph shooting button 512 which is the shutter button of the camera 12, the back for returning to the previous screen TOP screen 500, the photo shooting screen 510 on which the button 513 and the like are displayed is displayed on the touch panel type display unit 15 (step S 202).

When the user selects the photograph shooting button 512 or the like on this photograph shooting screen 510 (step S203 YES), the CPU11 reads the photograph data 511 taken as shown in FIG. 5B, The OK button 514 for saving the photographed picture data 511, the BACK button 513 for returning to the previous picture, and the like are displayed on the touch panel display section 15 (step S204).

When the user selects the OK button 514 on the picture determination screen 520 (YES in step S205), the CPU11 displays the picture data 511 displayed on the touch panel type display section 15 when the OK button 514 is pressed In the data storage area 16b or the like of the storage unit 16 (step S2 06).

Further, as shown in FIG. 5B, a red dot mark indicating that it is selected is displayed on the OK button 514. On the touch panel type display section 15, the saving confirmation screen 530 for confirming saving of the determined picture data 511 is shown in FIG. 5 (c) (step S207).

On the saving confirmation screen 530, in addition to the photograph data 511 determined to be saved as shown in FIG. 5 (c), together with a message such as “Confirmation image saved” and the like, the photograph shooting process is completed OK button 531 is also displayed.

Then, when the OK button 531 is selected on the saving confirmation screen 530 shown in FIG. 5C. (Step S208 YES). The CPU11 returns to display processing on the photograph shooting screen 510 of step S202 for shooting the next photograph.

In addition, although the photo data 511 photographed at the billboard installation site may be one for the same billboard installation place, it is preferable to keep the distance with respect to the same billboard installation place as much as possible. Like the image data 511 such as the short distance about 20 m away from the billboard installation, the medium distance about 50 m away, the long distance about 100 m away, etc. or display a message on this saving confirmation screen 530 so as to shoot multiple picture data 511 for the same place of installation. Before returning to the display processing of the photograph shooting screen 510 in step S202, the screen for confirming whether or not the multiple photograph data 511 has been photographed is changed by changing the distance for the same installation place. Or in order not to return to the display processing of the photograph shooting screen 510 of the step S2 02 unless the multiple photograph data 511 is photographed by changing the distance for the same installation place. It is OK to program this way.

When changing the distance for the same billboard installation place and shooting multiple pieces of picture data 511, it is possible to understand the situation of short distance, medium distance, and long distance regarding the installation place of the billboard, and the multiple photo data 511 It is possible to recognize traffic conditions of pedestrians, cars and the like at different timings (time) at the same billboard setting place by means of multiple pieces of photo data 511. There is a merit that it is possible to more accurately grasp the scenery and the traffic condition of the billboard installation place than in the case of the picture data 511.

When the photograph shooting button 512 is not selected on the photograph shooting screen 510 shown in FIG. 5A (step S203 NO) and the BACK button 513 is selected (step S209 YES), The CPU11 terminates the camera application 16a3 (step S210) and returns to the display processing of the TOP screen 500 of step S100 shown in FIG. 2.

(2) Silhouette creation processing Next, the silhouette creation processing in step S300 shown in FIG. 2 will be described in detail.

### (2-1) Board Silhouette Creating Process

FIG. 6 is a flowchart showing a detailed processing procedure of the first half of the silhouette creating process at step S300 shown in FIG. 2 in the board silhouette creating process.

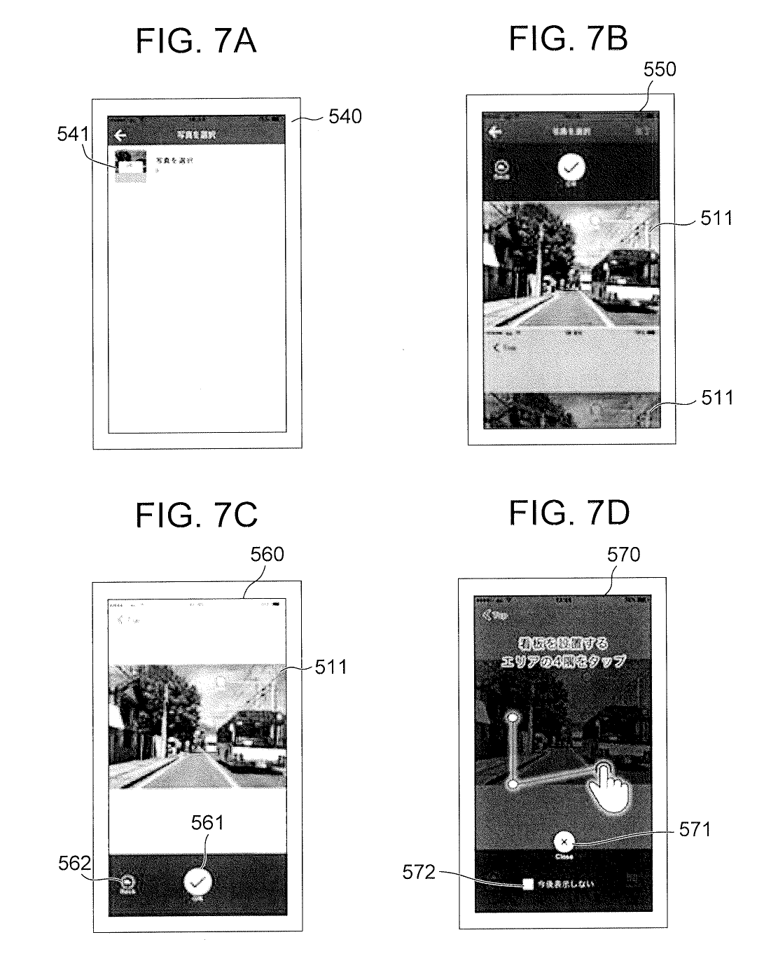

As shown in FIG. 2, when the user selects the silhouette creation button 502 or the like on the TOP screen 500 shown in FIG. 3B (step S120 YES), the CPU11 displays the billboard by execution of the data generation/transmission application 16a2 shifts to the silhouette creation processing of step S300, and first, a photo folder selection screen 540 showing the saved contents of the folder of the storage section 16 storing the picture data 511 as shown in FIG. 7A (Step S301).

On the photo folder selection screen 540, as shown in FIG. 7A, an icon 511 such as a thumbnail image of the photo data 511 saved in each photo folder is displayed.

The photo folder is automatically created when the picture data 511 is saved in the data storage area 16b of the storage unit 16 by the photograph shooting process of step S200. For example, it is created for each photographing process in step S200. Therefore, when the same billboard placement site is photographed multiple times with near, middle, long distances etc. by the photograph shooting process of step S200 once, the near, mid and long distance picture data 511 are saved in the same photo folder. Incidentally, although only one icon 541 of the photo folder is displayed on the photo folder selection screen 540 shown in FIG. 7A, photographing of the multiple billboard installation place is performed and each time the photograph shooting of the step S200 When the process is executed, a photo folder is created for each billboard installation location, and the icon 541 of the photo folder for each billboard installation location is displayed in a multiple manner.

When the icon 541 of the photo data 511 is selected on the photo folder selection screen 540 shown in FIG. 7A(YES in step S302), the CPU11 determines whether the icon 541 is saved in the selected photo folder, the photo data selection screen 550 as shown in FIG. 7 (b) in which 1 or multiple pieces of photo data 511 are displayed is displayed on the touch panel type display section 15 (step S 303).

Then, on the photo data selection screen 550, when the user selects one photo data 511 from among the one or multiple photo data 511 saved in the photo folder by tapping etc. (step S304 YES), The CPU11 displays the selected photograph determination screen 560 as shown in FIG. 7C on the touch panel type display unit 15 (step S305).

On the selected photograph determination screen 560, together with the photograph data 511 selected by the user, the OK button 516 for deciding to create a billboard silhouette with respect to this picture data 511, and a picture data selection, the BACK button 522 for returning to the screen 550, and the like are displayed.

When the user selects the OK button 561 on this selection photograph determination screen 560 (YES in step S306), the CPU11 displays the screen silhouette creation explanation screen 570 as shown in FIG. 7D on the touch panel display Section 15 (step S 307).

In the screen silhouette creation explanation screen 570 shown in FIG. 7D, for example, a message such as “tap the four corners of the area where the billboard is to be installed” and a tap method of the area etc. are displayed, the close button 571 for closing this board silhouette creation explanation screen 570 is displayed. Further, by selecting the screen non-display button 572, it is possible to prevent the board silhouette creation explanation screen 570 from being displayed in the future.

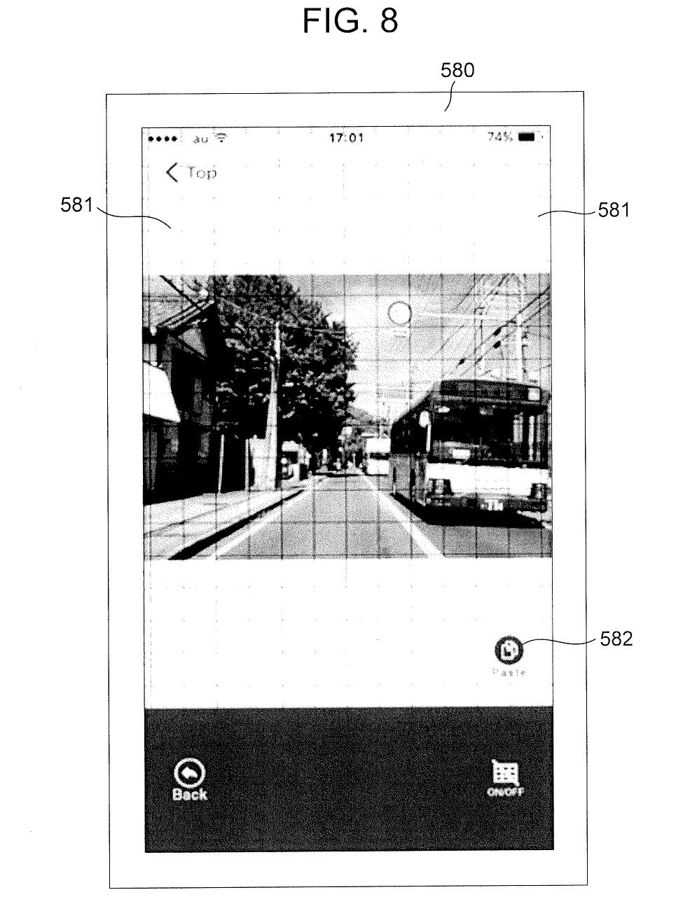

When the user taps (selects) the close button 571 on the board silhouette creation explanation screen 570 (YES at step S308), the CPU11 displays the silhouette creation screen 580 as shown in FIG. 8 on the touch panel type display unit 15 (Step S309).

In the silhouette creation screen 580, as shown in FIG. 8, the picture data 511 is displayed, and on the picture data 511, the advertisement contents to be posted on the board face of billboard are not posted on. In order to make it easier to create a board surface silhouette image 585 which is the silhouette image of board surface, the grid of predetermined pitch serving as a reference when generating a board surface silhouette image 585, that is, the grid of vertical and horizontal grid lines 581 are superimposed and displayed.

Therefore, when the user creates the board silhouette image 585 on the photo data 511, the board surface silhouette image 585 does not incline obliquely or the like with reference to the grid line 581 of a predetermined pitch. The silhouette image 585 can be easily and reliably created.

Note that, in this silhouette creation screen 580, as shown in FIG. 8, the board silhouette image 585 and the leg silhouette image 621 which the user has once created and saved are read out and are displayed on the silhouette creation screen 580, the Paste button 582 for superimposing and displaying on the photo data 511 that is being displayed is also displayed. To read out the board silhouette image 585 once created and saved and the leg silhouette image 621 and copy it on the photo data 511, tap the Paste button 582 to select it. Incidentally, the pasting process of the board surface silhouette image 585 and the leg silhouette image 621 in the case where the Paste button 582 is selected will be described later.

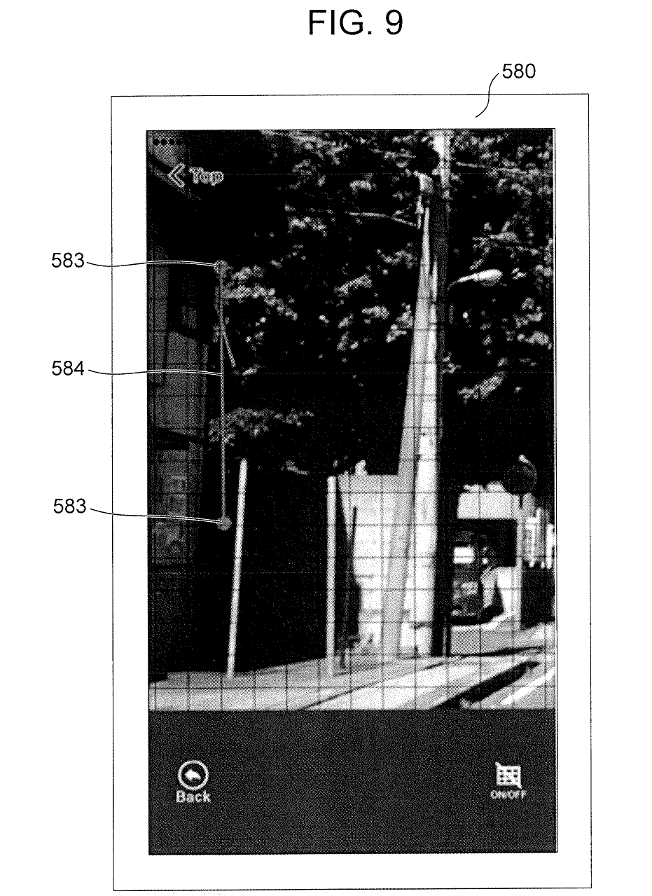

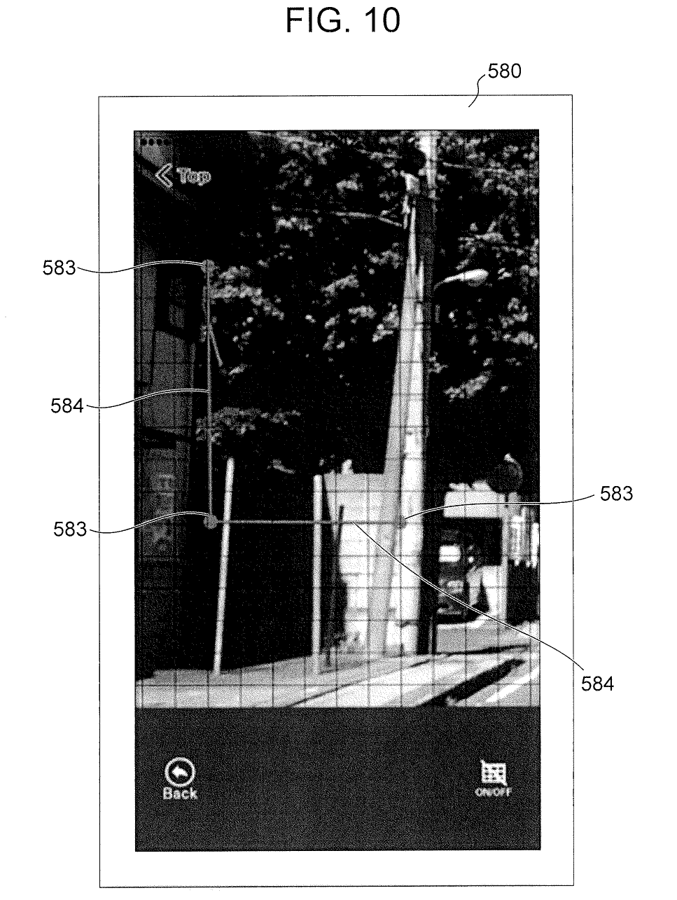

When the user taps on the picture data 511 (YES in step S311) without selecting the Paste button 582 on the silhouette creation screen 580 shown in FIG. 8 (step S310 NO), as shown in FIGS. 9 and 10, the tapped tap point 583 on the photograph data 511 is displayed with a point such as a red circle (hereinafter referred to as a red dot point) together with two points The tapped points 583 tapped above are connected by the red outline 584 and displayed on the picture data 511 (step S 312).

The silhouette creation screen 580 shown in FIG. 9 shows a state in which two points are tapped on the enlarged picture data 511 rather than the silhouette creation screen 580 shown in FIG. 8, and the enlarged picture data 511, two tap points 583 which are contour points at the four corners of the billboard are displayed above, the along with contour line 584 connecting two tap points 583 is displayed on the picture data 511.

On the other hand, in the silhouette creation screen 580 shown in FIG. 10, the state where three points are tapped on the enlarged picture data 511 than the silhouette creation screen 580 shown in FIG. 8 as in FIG. 9, three tap points 583 to be the outline points of the four corners of the billboard are displayed on the enlarged photo data 511, the contour line 584 connecting three tap points 583 is displayed on the two pieces of picture data 511. Incidentally, the CPU11 sequentially connects the tapped tap points 583 with the contour line 584.

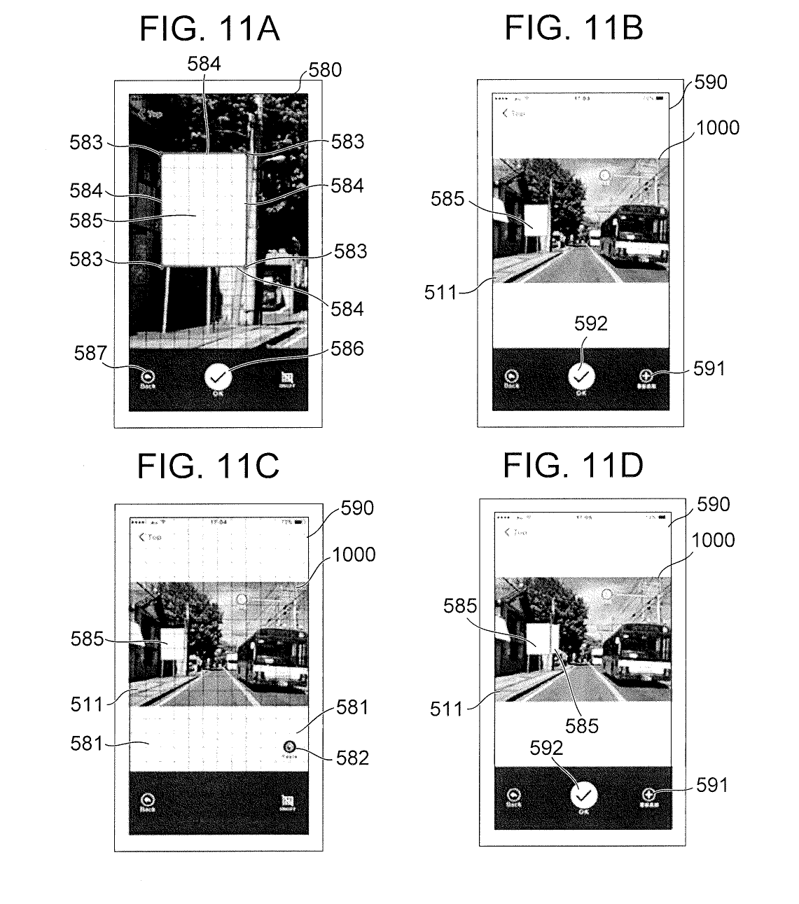

Then, when four points are tapped and four tap points 583 are displayed on the picture data 511 of the silhouette creation screen 580 (YES in step S 313), for example, as shown in FIG. 11 (a), the CPU11 connects all four tap points 583 by a contour line 584, and the board surface silhouette image 585 of the billboard whose inside surrounded by the four tap points 583 and the four contour lines 574 is painted with yellow color or the like is displayed on the picture data 511 (step S314).

In the case where the board surface silhouette image 585 of the billboard whose inside surrounded by the four tap points 583 and the four outline lines 584 is painted with, for example, yellow color or the like is bent, the user does not select the OK button 586 (NO in step S315), and presses the BACK button 587 to return to the previous screen. Alternatively, if the tap point is moved with a finger or the like, the CPU11 corrects the tap point (step S316).

Then, on the silhouette creation screen 580, a silhouette image 584 of the board surface as shown in FIG. 11 (a) is displayed on the picture data 511, when the OK button 58 6 is selected by the user (YES in step S 315), the CPU11 displays on the touch panel type display unit 15 the board silhouette completion screen 590 on which the billboard installation data 1000 obtained by combining the board silhouette image 585 on the photo data 511 as shown in FIG. 11 (b) is displayed (Step S317).

In addition, as shown in FIG. 11 (b), a billboard additional button 591, etc. for adding board surface silhouette image 585 to the same billboard installation data 1000 is also displayed on this board surface silhouette completion screen 590 that is displayed.

Therefore, when adding a board surface silhouette image 585 to the same billboard installation data 1000, the user selects a billboard addition button 591 of the board silhouette completion screen 590. On the other hand, if the board silhouette image 585 is not added to the same billboard installation data 1000, the billboard addition button 591 is not selected.

When the billboard addition button 591 is selected on this board surface silhouette completion screen 590 (YES in step S318), the CPU11 returns to the processing in step S309, as shown in FIG. 11C, on the screen silhouette completion screen 590 on which the billboard installation data 1000 which synthesized the board silhouette image 585 on the picture data 511 is displayed, the grid line 581 of the predetermined pitch displayed also on the silhouette creation screen 580 of FIG. 8 is superimposed and displayed on the touch panel type display unit 15.

Then, the CPU11 repeatedly performs the processing of the above-described steps S307 to S317, it is possible to generate the billboard installation data 1000 synthesized by adding the board silhouette image 585 on the picture data 511 to the board surface silhouette completion screen 590.

FIG. 11D shows a screen silhouette completion screen 590 displaying billboard setting data 1000 obtained by combining two pieces of the board silhouette image 585 added on the photo data 511.

Thus, the user selects the billboard addition button 591 on the board silhouette completion screen 590 (YES in step S318), one or multiple board silhouette images 585 can be added on the photo data 511 and synthesized.

When the OK button 592 is selected on the screen silhouette completion screen 590 displaying the billboard installation data 1000 in which one or multiple board surface silhouette images 585 are combined on the picture data 511 S 319 YES), the CPU11 completes the board silhouette creation processing shown in FIG. 6 and shifts to the leg silhouette creation processing of the sign shown in FIG. 12.

(2-2) Leg Silhouette Creating Process

FIG. 12 is a flowchart showing a detailed processing procedure of the second half leg silhouette creating process in the silhouette creating process of Step S300 shown in FIG. 2.

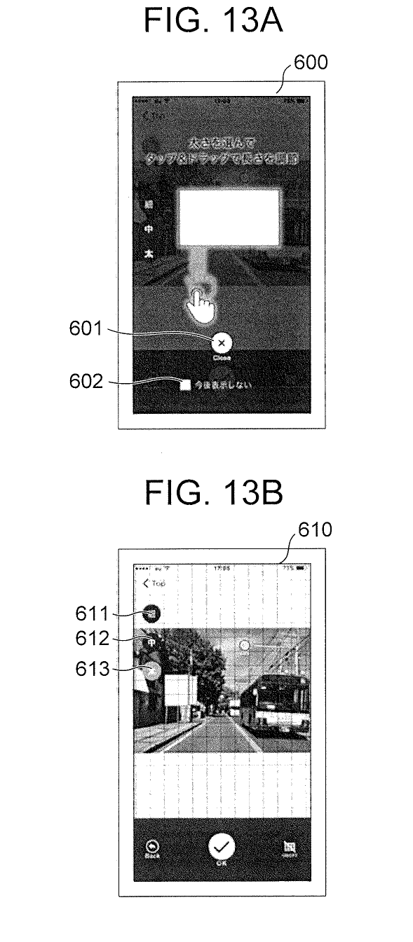

When the OK button 592 is selected in the process of step S319 in FIG. 6 (YES in step S199) and the process shifts to the leg silhouette creation process of the billboard shown in FIG. 12, first, as shown in FIG. 13A The leg silhouette creation explanation screen 600 is displayed on the touch panel type display unit 15 (step S330).

Leg silhouette creation explanation screen 600, along with a message such as “Choose the size and adjust the length by tapping & dragging” as shown in FIG. 13A, this leg silhouette creation explanation screen 600, and a screen disappearance display button 602 for preventing future display of the leg silhouette creation explanation screen 600 are also displayed.

When the close button 601 is selected (step S331 YES), the CPU11 is generated by the board surface silhouette creation processing shown in FIG. 6 as shown in FIG. 13B Leg size setting buttons 611 to 613 of fine, middle, thick indicating the thickness of the sign of the billboard on the finished screen silhouette completion screen 590, and the leg silhouette creation initial screen 610 in which the grid lines 614 having a predetermined pitch are displayed in an overlapped manner on the touch panel type display unit 15 (step S332).

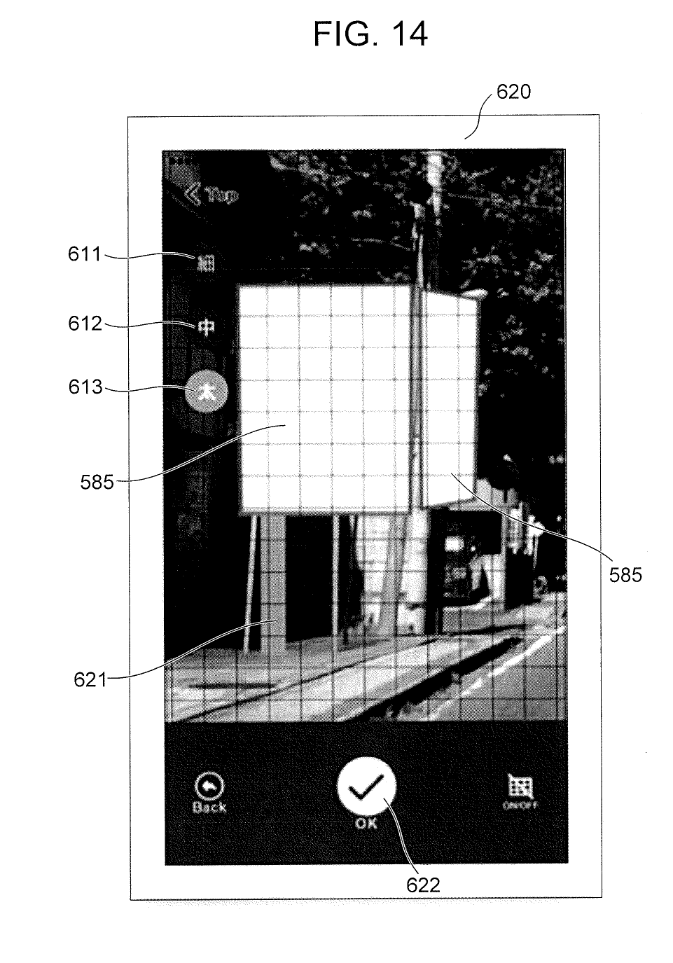

Then, in the Leg silhouette creation initial screen 610 as shown in FIG. 13B, the leg size setting buttons 611 to 613 of fine, middle, thick, when any one is selected (step S 333 YES), the edge of one or multiple board surface silhouette image 585 is tapped on the picture data 511 and dragged (step S344 YES), as shown in FIG. 14, the CPU11 selects one of small, medium, and thick selected by the leg size setting buttons 611 to 613 to change the board surface silhouette image 585 to Leg silhouette image 621 on the touch panel type display unit 15 (step S335).

In addition, in the leg silhouette creation screen 620 shown in FIG. 14, two board surface silhouette images 585 are synthesized on the picture data 511, and thick of thickness size setting button 613 is selected and one thick leg silhouette image 621 is drawn from the board surface silhouette image 585 on the left side.

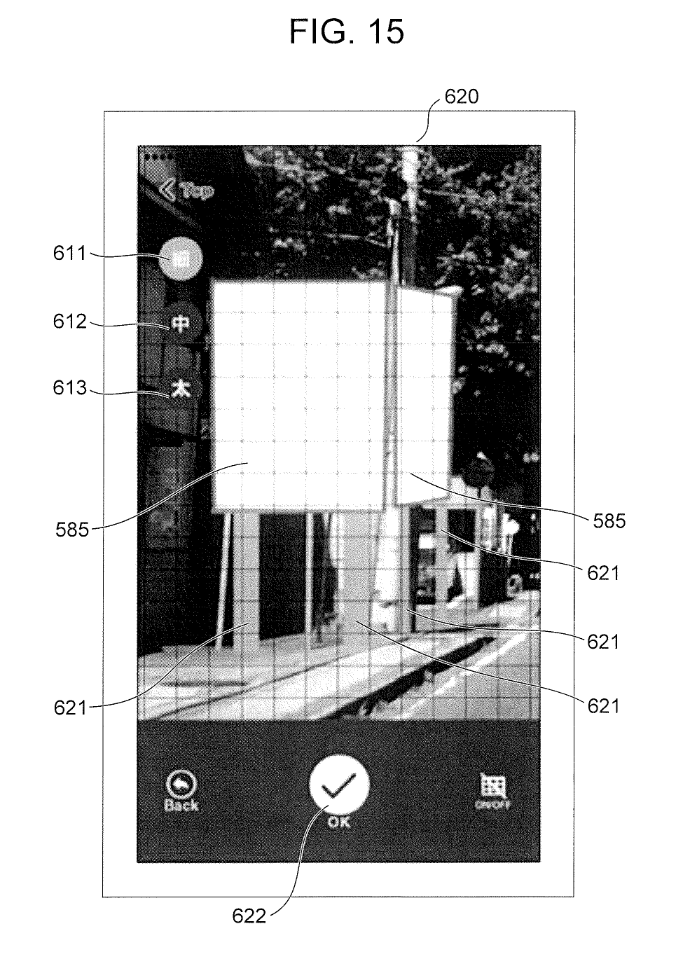

Then, when the process of tapping and dragging the end portion of board surface silhouette image 585 in step S334 is repeated, as in the leg silhouette creation screen 620 shown in FIG. 15, tapping and dragging twice for each of the two board surface silhouette images 585 displayed on the picture data 511, thick and fine can be drawn for the total of four leg silhouette images 621.

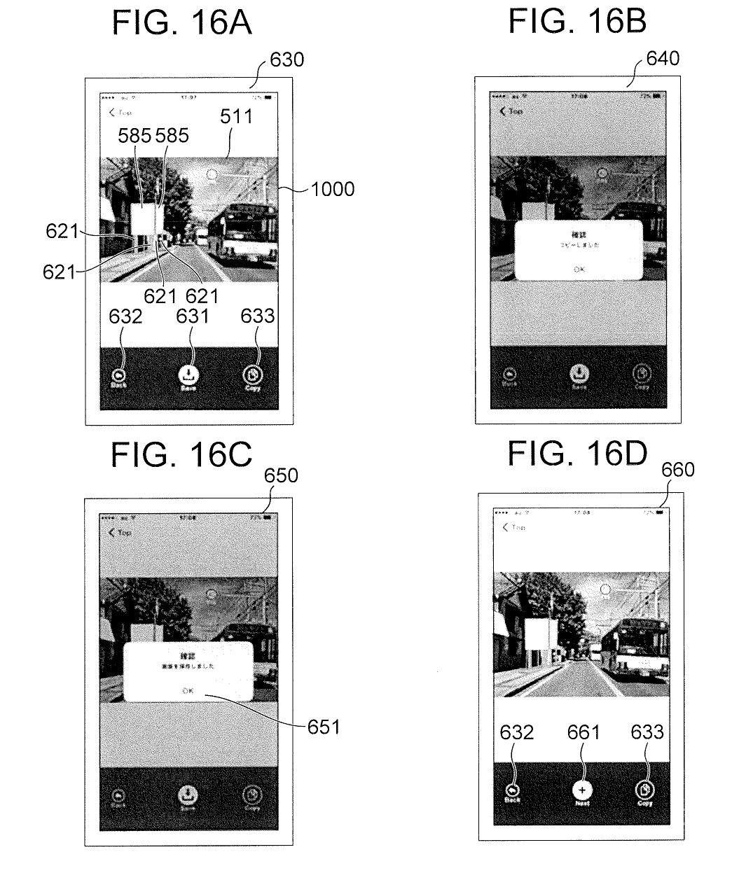

When OK button 622 is selected in leg silhouette creation screen 620 (step S336 YES), the CPU11 displays on the picture data 511 as shown in FIG. 16A. The billboard silhouette completed screen 630 on which billboard setting data 1000 in which board silhouette image 585 and leg silhouette image 621 are synthesized is displayed on touch panel type display unit 15 (Step S337).

In the billboard silhouette complete screen 630 shown in FIG. 16A, SAVE button 641 for storing billboard silhouette completed screen 630, BACK button 642 for returning to the leg silhouette creation screen 620 shown in the previous screen FIG. 15, COPY button 633 for copying board surface silhouette image 585 and leg silhouette image 621 in billboard silhouette completed screen 630 are displayed.

Therefore, if the COPY button 633 has been selected by the user (YES in step S338), the CPU11 displays the board surface silhouette image 585 and the leg silhouette image 621 displayed on the photograph data 511 in the billboard silhouette complete screen 630 as shown in FIG. 16A on the memory 13 and the storage unit 16 or the like (YES in step S33 9), and temporarily saves the billboard silhouette copy completion screen 640 as shown in FIG. 16B is displayed on the touch panel type of display section 15 (step S350).

On the other hand, when SAVE button 641 is selected by the user (YES at step S 340), in the billboard silhouette complete screen 630 as shown in FIG. 16A, the CPU11 displays the billboard installation data 1000 in which the board surface silhouette image 585 and the leg silhouette image 621 are combined on the photo data 511 In the memory 13 or the storage unit 16, and displays the billboard silhouette saving completion screen 650 as shown in FIG. 16C on the touch panel type display unit 15 (step S341).

OK button 651 is displayed on the billboard silhouette saving completion screen 650 together with the message confirmation image saved as shown in FIG. 16C.

Then, when the user selects OK button 651 on the billboard silhouette saving completion screen 650 shown in FIG. 16C (YES at step S342), the CPU11 displays billboard setting data 1000 obtained by combining the board surface silhouette image 585 and the leg silhouette image 621 on the photo data 511 as shown in FIG. 16D Billboard silhouette complete storage screen 660 is displayed on the touch panel type display unit 15 (step S343).

In the billboard silhouette complete save screen 660 shown in FIG. 16D, unlike the billboard silhouette complete screen 630 shown in FIG. 16A, instead of the SAVE button 641 NEXT button 661 is displayed to generate billboard setting data 1000 of FIG. 16A, the billboard silhouette complete storage screen 660 shown in FIG. 16D also includes the BACK button for returning to the previous screen 642, the COPY button 633 for copying board silhouette image 585 and leg silhouette image 621 are displayed.

When the user selects the NEXT button 661 on billboard silhouette complete save screen 660 shown in FIG. 16D (YES at step S 344), returning to the process in step S301 shown in FIG. 6, the CPU11 returns to the photo folder selection screen 540 as in FIG. 7A so that the user can select another photo data 51 saved in the folder, and executes the process from step S301 onward in FIG. 6 for another photo data 51.

Specifically, when the user selects thumbnail image icon 541 of photo data 511 on the same photo folder selection screen 540 as in FIG. 7A (step S 302). As shown in FIG. 17A, the CPU11 selects the same photo data selection screen 550 (see FIG. 7B) for selecting the list of another photo data 51 saved in the folder by the user on the touch panel type display unit 15 (step S 303).

Photo data selection screen 550 shown in FIG. 17A, similarly to Photo data selection screen 550 shown in FIG. 7B, when the user selects 1 Or multiple photo data 511 is stored, it is possible to combine the board surface silhouette image 585 and the leg silhouette image 621 on the photo data 511 already combined with the completed photo sign data 1000 511, another photo data 511 is selected.

Then, if the user selects another picture data 511 different from the picture data 511 which already completed the billboard installation data 1000 which synthesized the board silhouette image 585 and the leg silhouette image 621 on the picture data 511 (Step S304 YES). As shown in FIG. 17B, the CPU11 displays the selected photograph determination screen 560 on which another photograph data 511 is displayed on the touch panel type display unit 15 (step S 305).

Then, the user selects the OK button 561 on this selection photograph decision screen 560 (YES in step S306), Sheet Silhouette Creation Explanation Screen 570 as shown in FIG. 7D is displayed on the touch panel type display unit 15 (Step S307), and the close button 571 is tapped (selected) on the screen silhouette creation explanation screen 570 (YES in step S308), the CPU11 displays the same silhouette creation screen 580 as shown in FIG. 8C on the touch panel type display unit 15 (step S309).

### (Pasting Silhouette Image of Board Surface 585 and Leg Silhouette Image 621 to Other Photograph Data)

In the silhouette creating screen 580 shown in FIG. 17C, a different silhouette creating screen 580 shown in FIG. 8 511 is displayed, similarly to the silhouette creation screen 580 shown in FIG. 8, vertical and horizontal grid lines 581 with the predetermined pitch and the Paste button 582 are displayed.

Here, since the image data 511 saved in the same folder is the image data 511 of near, middle, long distance, and the like changing the shooting distance for the same billboard placement place as described above, basically the configuration and form of the board surface silhouette image 585 and the leg silhouette image 621 should be the same.

Therefore, when the Paste button 582 is tapped and selected on the silhouette creation screen 580 shown in FIG. 17C (YES in the step S310), for example, in order to allow the user to confirm the pasting of the board silhouette image 585 and the leg silhouette image 621, the CPU11 displays the pasting confirmation screen 670 as shown in FIG. 17D on the touch panel type display unit 15 (step S320).

On the paste confirmation screen 670, as shown in FIG. 17 (d), both the OK button 671 and the cancel button 672 are displayed on the picture data 511 on both the message “Do you want to paste the confirmation copy?” is displayed.

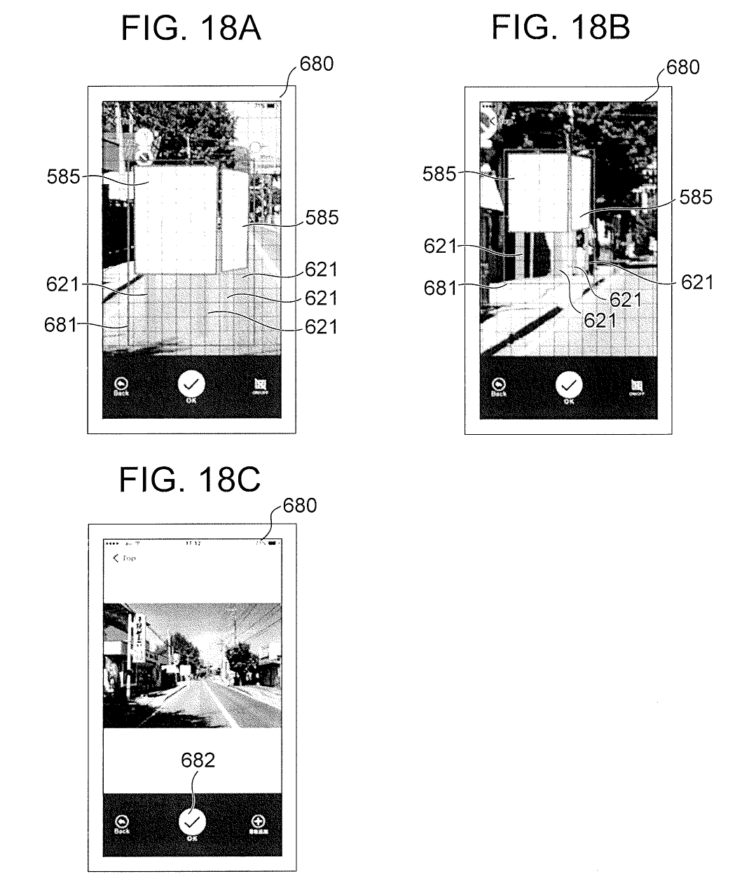

When the user selects the OK button 671 on the pasting confirmation screen 670 shown in FIG. 17D (YES at step 321), the CPU11 displays the pasted completion screen 680 combined by combining the board silhouette image 585 and the leg silhouette image 621 which have been copied on the picture data 51 as shown in FIG. 18A and displays it on the touch panel type display unit 15 (step S 322).

Here, on the pasting completion screen 680, the CPU11 overlays the board surface silhouette image 585 and the leg silhouette image 621 that have been copied on the photo data 51 as shown in FIG. 18A. In addition to displaying the silhouette image 585 and the leg silhouette image 621 at the same scale ratio and also simultaneously moving the board silhouette image 585 and the leg silhouette image 621, the enlargement/reduction pinch roller line 681 is displayed around the board silhouette image 585 and the leg silhouette image 621.

Therefore, in the information processing communication terminal 11 of this embodiment, when the user pastes and synthesizes the board silhouette image 585 previously created and stored in the new photo data 51 and the leg silhouette image 621, the two fingers pinch out (expand) or pinch in (narrow) the enlargement/reduction pinch column line 681 surrounding the board surface silhouette image 585 and the leg silhouette image 621. In response to the enlargement/reduction of the enlargement/reduction pinch column line 68 1, the CPU11 enlarges or reduces the board silhouette image 585 and the leg silhouette image 621 combined and displayed in the new picture data 51 at the same scale ratio.

Also, if the user drags the enlargement/reduction pinch column line 681 displayed on the new picture data 51 with his/her finger, the CPU11 simultaneously moves the board surface silhouette image 585 and the leg silhouette image 621 displayed inside the enlarging/reducing pinch column line 681 on the new photo data 51. Incidentally, the enlargement/reduction process and the movement process of the board surface silhouette image 585 and the leg silhouette image 621 using the enlargement/reduction pinch column line 681 are as follows. You can do either first, or at the same time.

For example, as shown in FIG. 18 (a), in the pasting completion screen 680 in which the board silhouette image 585 and the leg silhouette image 621 are largely pasted on the road of the photo data 511, pinch in using the two fingers to expand/contract pinch column line 681 around the board surface silhouette image 585 and the leg silhouette image 621. As shown in FIG. 18 (b), the board surface silhouette image 585 and the leg silhouette image 621 can be reduced to the picture data 51 according to the size of the enlargement/reduction pinch column line 681. Particularly, in the case where the board surface silhouette image 585 and the leg silhouette image 621 created on the short distance photograph data 511 at the same billboard setting place are stored and pasted on the medium distance and long distance photo data 511, The sheet silhouette image 585 and the leg silhouette image 621 will be reduced, which is extremely convenient.

Further, as shown in FIG. 18A, in the pasting completion screen 680 in which the board silhouette image 855 and the leg silhouette image 621 are largely pasted on the road of the photo data 511, the board surface silhouette image 585 and the legs by dragging the enlargement/reduction pinch roller line 681 around the silhouette image 621 using one finger, the CPU11 is surrounded by the enlargement/reduction pinch column line 681 as shown in FIG. 18 (b) the silhouette image 585 and the leg silhouette image 621 can be moved to the intended billboard installation place on the picture data 51.

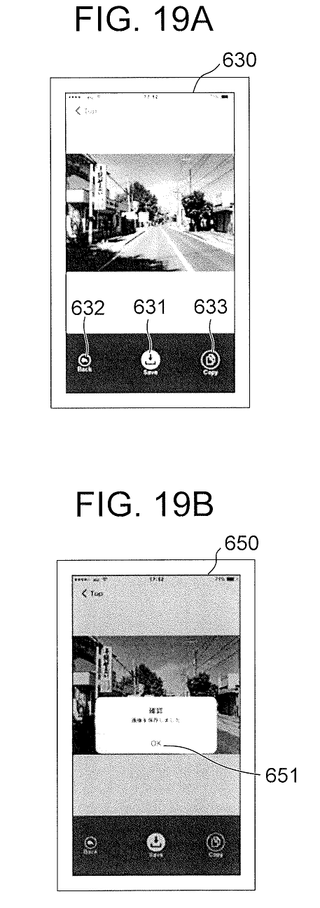

After pasting the sheet silhouette image 855 and the leg silhouette image 621 on the photograph data 51 as shown in the pasting completion screen 680 shown in FIG. 18C, the enlarged/reduced pinch column line 681 causes the board surface silhouette after enlarging/reducing the image 585 and the leg silhouette image 621 to the optimum size and moving it to the signboard installation place, when the user taps on the OK button 682 (“YES” in step S336), the billboard silhouette complete screen 630 as shown in FIG. 19A is displayed on the touch panel type display unit 15 (step S 337), the billboard silhouette complete screen 630 shown in FIG. 19A is generated by pasting the board surface silhouette image 585 and the leg silhouette image 621 on the photo data 511 by the Paste button 582.

Other than that, it is the same as the signboard silhouette complete screen 630 shown in FIG. 16A created by drawing the board silhouette image 585 and the leg silhouette image 621 on the photo data 511.

Then, when the SAVE button 641 is selected on the billboard silhouette complete screen 630 as shown in FIG. 19A (YES in step S 340), the CPU11 displays the billboard installation data 1000, in which the board silhouette image 585 and the leg silhouette image 621 are combined on the photo data 511 displayed on the billboard silhouette complete screen 630 shown in FIG. 19A, saved as memory 13 or storage 16. The billboard silhouette saving completion screen 650 as shown in FIG. 19B is displayed on the touch panel type display section 15 (step S341).

Incidentally, for the third piece of the long distance photograph data 511, for example, in the same manner as the second piece of medium distance picture data 511, paste the board surface silhouette image 585 and the leg silhouette image 621 on the photo data 511 by the Paste button 582. Billboard setting data 1000 in which the board silhouette image 585 and the leg silhouette image 621 are synthesized on the picture data 511 displayed on the billboard silhouette complete screen 630 shown in FIG. 19A can be saved in the memory 13 or the storage unit 16.

(3) Location Information Setting/Mail Transmission Processing Next, the position information setting/mail transmission processing in step S400 shown in FIG. 2 will be described in detail.

As shown in FIG. 2, when the user selects the position information setting mail transmission processing button 503 by tapping on the TOP screen 500 shown in FIG. 3 (b) (step S130 YE S), the CPU11 executes the position information setting/mail transmission processing 400 detailed in FIG. 16.

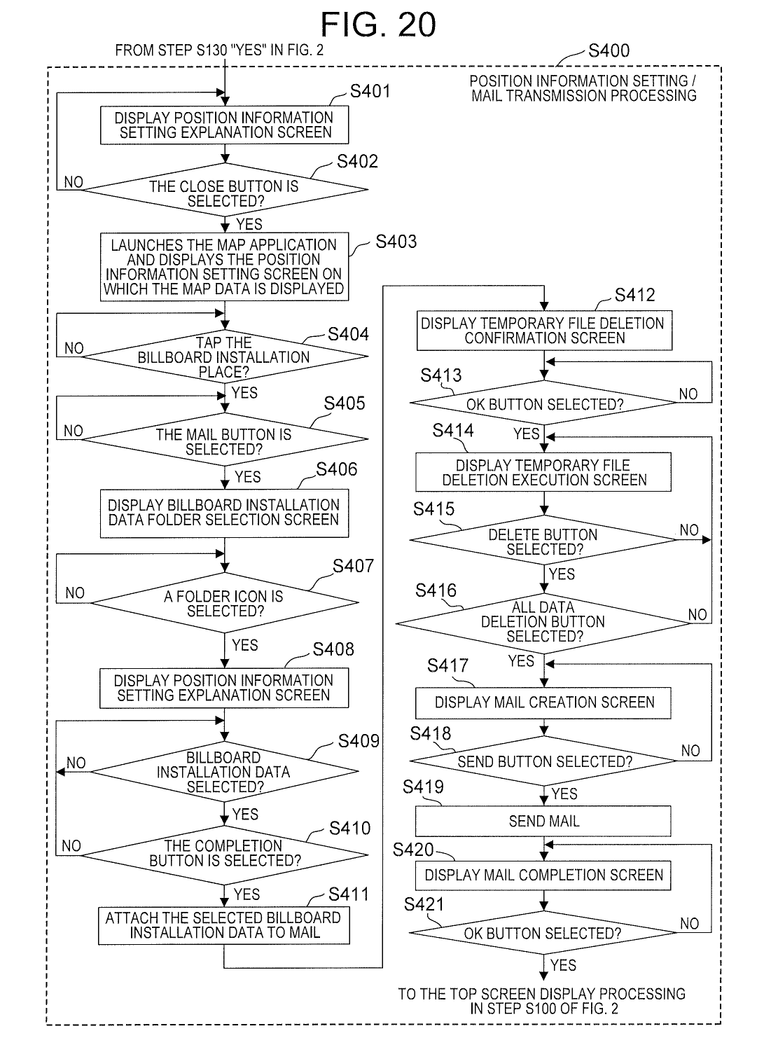

FIG. 20 is a flowchart showing a detailed processing procedure of the position information setting/mail transmission processing 400 shown in FIG. 2.

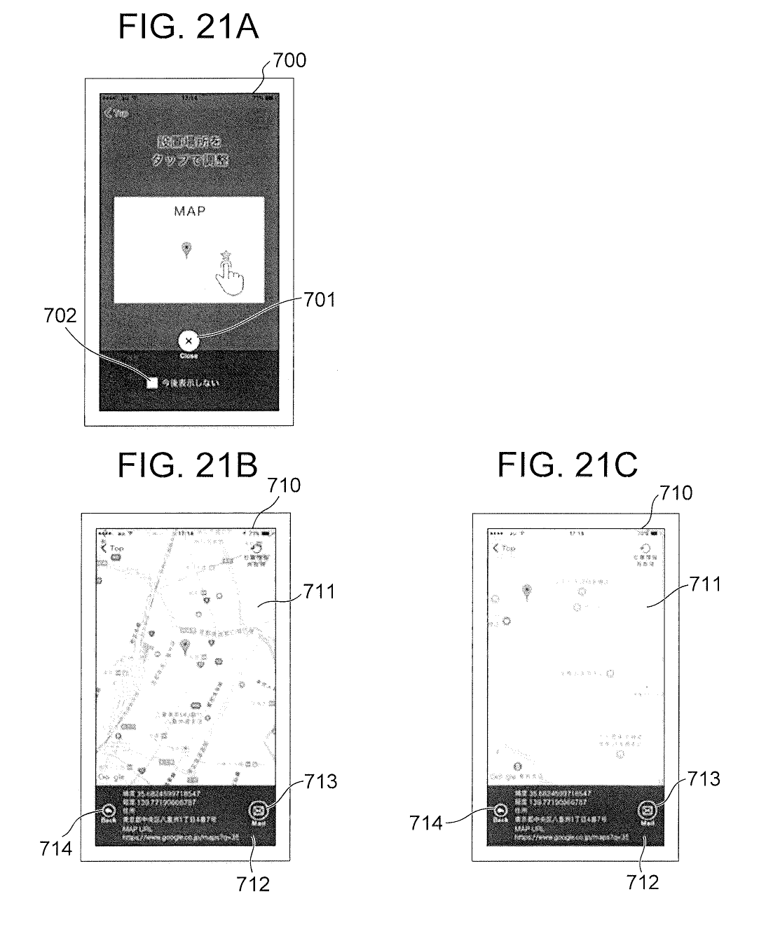

Specifically, as shown in FIG. 20, the CPU11 first displays a position information setting explanation screen 700 as shown in FIG. 21A on the touch panel type display unit 15 (step S401).

On the position information setting explanation screen 700, as shown in FIG. 21A, together with a message such as Adjust with installation location by tap, a picture urging the user to tap on the map. Furthermore, the Close button 701 for closing the position information setting explanation screen 700 and a screen no display button 702 for disabling display of the position information setting explanation screen 700 are also displayed.

Therefore, when the user selects the Close button 701 on the position information setting explanation screen 700 (YES at step S 402), the CPU11 closes the position information setting explanation screen 700 shown in FIG. 21A, activates the map application 16a4, displays the position information setting screen 710 as shown in FIG. 21B on the touch panel type display unit 15 (Step S403).

On the position information setting screen 710, as shown in FIG. 21B, map data 711 based on the position information of the information processing communication server 2 generated by the GPS module 17 based on the radio waves from the GPS satellites is displayed, the GPS position data display field 712 on which GPS position data is displayed is also displayed.

In the GPS position data display field 712, in addition to the GPS position data, a MAIL button 713 for mailing the GPS position data displayed in the GPS position data display field 712, and the like. BACK button 714 to return to the previous screen is also displayed.

Therefore, the user pinches out the map data 711 displayed on the position information setting screen 710 with his/her finger and enlarges or moves the map data 711 like the position information setting screen 710 shown in FIG. 21C to display the billboard installation location where the photograph was taken.

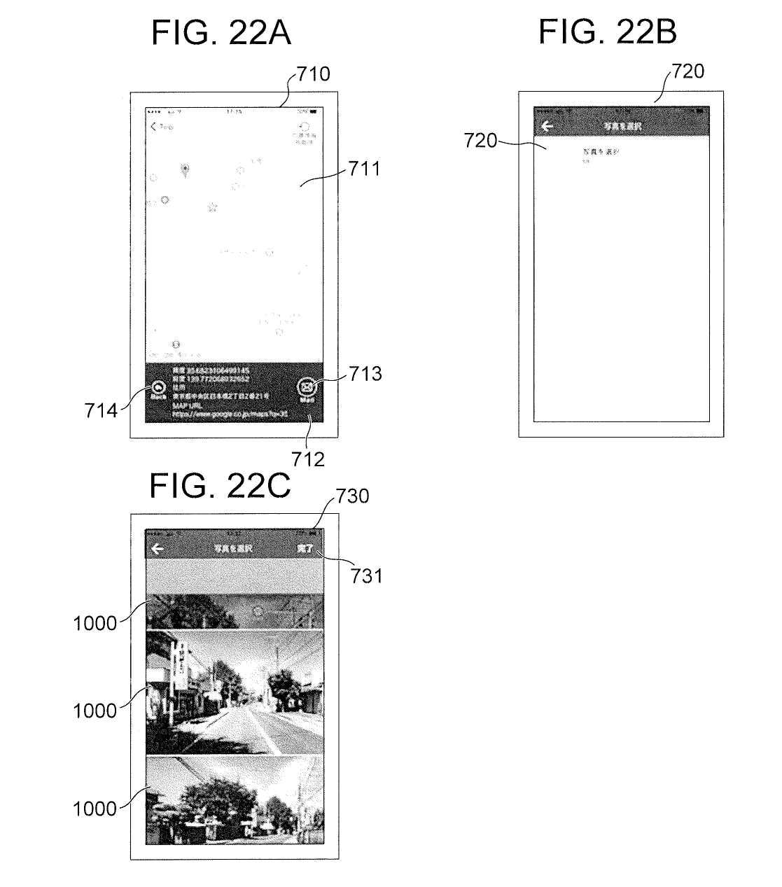

Then, in the position information setting screen 710 shown in FIG. 22A, the user taps the billboard installation location where the photograph was taken (step S404 YES) and further presses the MAIL button 713 (step S405 YES), the CPU11 displays the billboard installation data folder selection screen 720 as shown in FIG. 22B on the touch panel type display unit 15 (step S406).

On the billboard setting data folder selection screen 720, a sheet silhouette image 585 and a leg silhouette image 621 are superimposed on the photograph data 511 as shown in FIG. 22B. Icon 721 of the folder in which one or multiple billboard setting data 1000 is saved saved in the process of step S342 of the silhouette creation process in step S300 shown in FIG. 12 are displayed.

Therefore, if the user selects the icon 721 of the folder displayed on the billboard installation data folder selection screen 720 shown in FIG. 22B (YES at step S 407). The CPU11 displays the billboard installation data selection screen 730 as shown in FIG. 22C on the touch panel type display unit 15 (step S408).

On the billboard setting data selection screen 730, as shown in FIG. 22C, one or multiple billboard installation data 1000 saved in this folder in the process of step S342 of the silhouette creation processing in step S300 shown in FIG. 12, one piece or multiple pieces of photograph data 511 in which the sheet silhouette image 585 and leg silhouette image 621 are synthesized are displayed. The completion button 731 for completing the process of attaching the billboard installation data 1000 to the mail is displayed.

Therefore, the user taps and selects one or multiple billboard setting data 1000 to be attached to the mail on the billboard setting data selection screen 730 shown in FIG. 22C (YES in step S 409), when the completion button 731 is pressed (step S410 YES), the CPU11 activates the mail application 16a5 and attaches one or multiple billboard installation data 1000 selected by the user on the billboard setting data selection screen 730 shown in FIG. 22C to the mail (step S411).

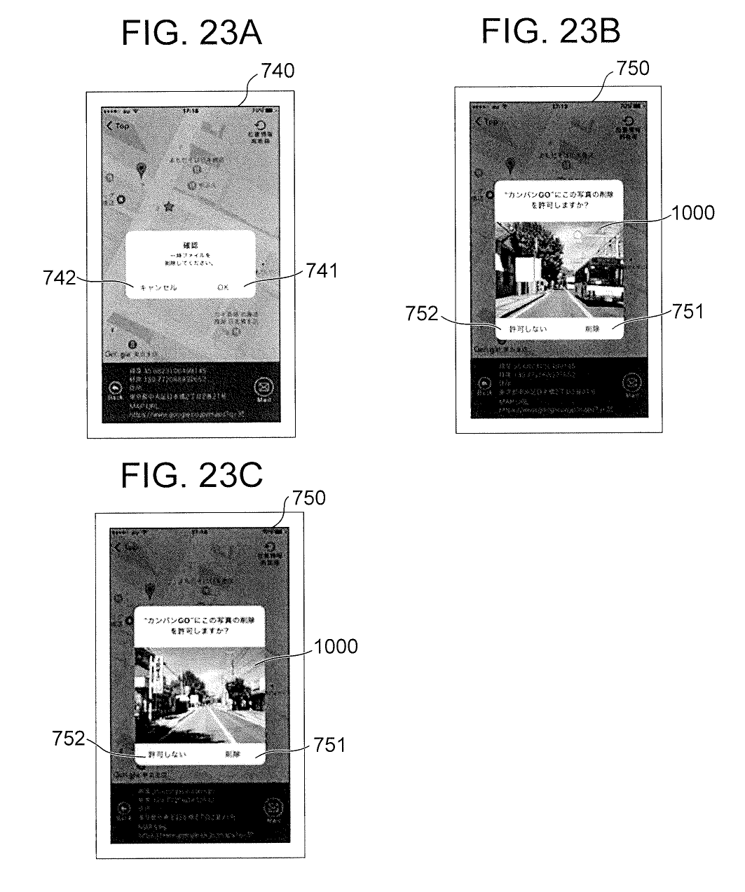

Next, the CPU11 displays the temporary file deletion confirmation screen 740 as shown in FIG. 23A on the touch panel type display section 15 in order to allow the user to confirm the billboard installation data 1000 attached to the mail (Step S412).

The temporary file deletion confirmation screen 740 includes an OK button 741 for executing a process of deleting a temporary file together with a message such as “Confirmation please delete temporary file” as shown in FIG. 23A the cancel button 742 for canceling the deletion processing of the temporary file is displayed.

Therefore, when the OK button 741 is selected on the temporary file deletion confirmation screen 740 shown in FIG. 23A (YES in the step S413), the CPU11 executes the processing shown in FIGS. 23B and 23, the temporary file deletion execution screen 750 as shown in FIG. 7 is displayed on the touch panel type display unit 15 for each of the one or more billboard setting data 1000 attached to the mail (step S414). (0119) On the temporary file deletion execution screen 750, as shown in FIG. 23B and 23C, “Do you want to allow deletion of this picture (billboard setting data 1000) on KanbanGO?”, the delete button 751 for executing the deletion processing of this picture (billboard setting data 1000) and a disapproval button 752 not permitting the deletion processing are displayed.

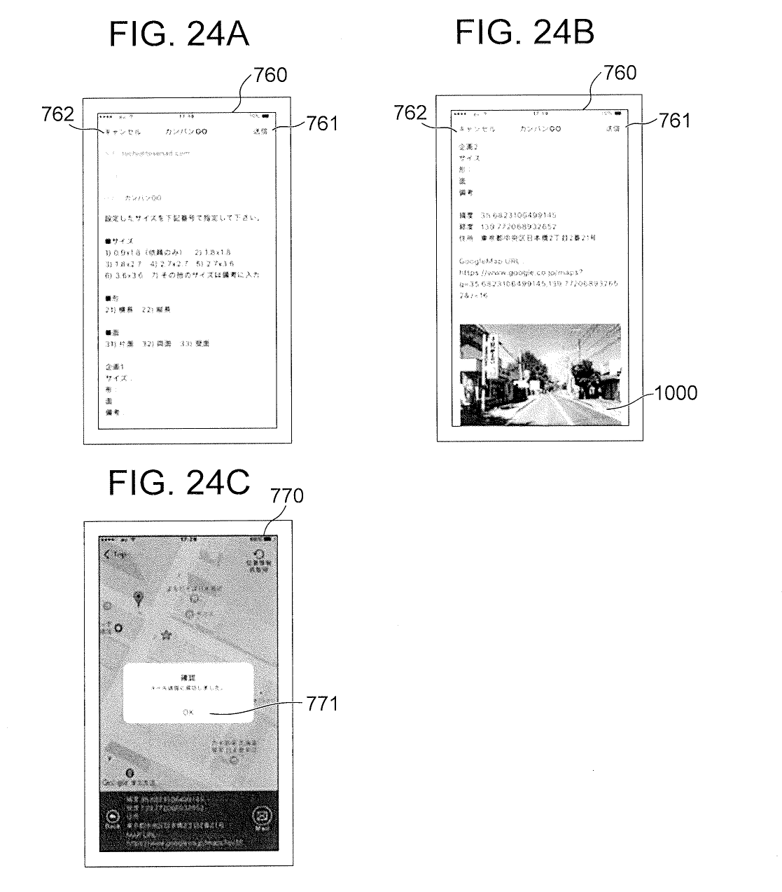

Therefore, when the user selects the delete button 751 for each temporary file deletion execution screen 750 as shown in FIG. 23B or FIG. 23C displayed on the touch panel type display unit 15 (step S415 YES), the touch panel type display unit 15 is displayed for each one or multiple billboard setting data 1000 attached to the e-mail (step S414). When the deletion button 751 is selected for all the billboard installation data 1000 attached to the mail in the processing of step S411 (YES in step S416), the CPU11 displays a mail creation screen 760 as shown in FIG. 24A on the touch panel type display unit 15 (step S417). Even if the delete button 751 is selected on the temporary file deletion execution screen 750, the billboard installation data 1000 saved in the data storage area 16b of the storage unit 16 is not deleted.

On the mail creation screen 760, for example, as shown in FIG. 24A, the board surface silhouette image 585 constituting the billboard installation data 100. That is, text data such as the size of the board surface silhouette image 585 synthesized to the photo data 511, the landscape, the portrait shape, even single sided, double sided, walled, etc. can be described. The keyboard (not shown) or the like is displayed on the touch panel type display unit 15, and the user directly inputs it or selects and inputs.

In addition, as shown in FIG. 24B, the mail creation screen 760 further includes the latitude and longitude data generated by the GPS module 17, the billboard acquired by the GPS module 17 and the map application 16a4, etc. address of installation place, URL data in map application 16a4. Furthermore, image data of one or multiple billboard setting data 1000 to be attached to the mail is also displayed.

Incidentally, for example, as shown in FIG. 24A, one or multiple billboard installation data 1000 is attached to the mail creation screen 760. The transmission button 761 for transmitting a mail describing the size of the board surface silhouette image 585, text data such as landscape, portrait shape, single-sided, double-sided, walled, etc. and the cancel button 762 for canceling the transmission of such mail are displayed.

Therefore, when the user selects the transmission button 761 of the mail creation screen 760 having the contents as shown in FIG. 24A and FIG. 24B (YES in step S 418), the CPU11 sends a mail in which one or multiple billboard installation data 1000 is attached by the mail application 16a2 and text data relating to the billboard and the installation place thereof and the latitude and longitude data etc. are set by the mail creation screen 760 to the information processing communication server 2 from the data communication unit 14 via the Internet 3 (step S419).

After sending mail attaching one or multiple billboard installation data 1000 in step S419, the CPU11 displays a mail transmission completion screen 770 as shown in FIG. 24C on the touch panel type display unit 15 (step S420).

On the mail transmission completion screen 770, an OK button 771 is displayed together with the message such as “Confirmation mail transmission was successful” as shown in FIG. 24C, and the OK button 771 is selected (Step S421 YES), then, the CPU11 ends the position information setting/mail transmission processing of step S400 shown in detail in FIG. 16, and returns to display processing of the TOP screen 500 of step S100 shown in FIG. 2. This completes the processing of the information processing communication terminal 1 side.

### (Operation of Information Processing Communication Server 2 Side)

In the information processing communication server 2, the information processing communication terminal 1 transmits gone or multiple pieces of information transmitted in the mail transmission processing of step S419 of the position information setting/mail transmission processing in step S400 shown in FIG. 16, when the data communication unit 26 receives the mail with the billboard installation data 1000 attached thereto and the text data on the billboard and its installation place and the latitude and longitude data are set via the Internet 3, the information processing communication server 2 executes the billboard installation service providing program 23a2 stored in the storage unit 23 to provide the billboard installation service.

Specifically, the CPU21 of the information processing communication server 2 downloads the billboard installation data generation and transmission application 16a2, downloads it, and executes the one or multiple billboard installation data 1000, text data on the billboard and its place of installation, latitude, longitude data, etc. on the display unit 25 for each mail, that is, for each billboard setting place, or the like. The information processing communication terminal 1 of the user who wishes to set up the billboard makes it browse via the Internet 3, and for users who like it, the billboard installation service such as billboard rental is performed.

From the user who wishes to install the billboard, on the display part of the information processing communication terminal 1 of the user, one or multiple billboard installation data 1000 for each billboard setting place, text data on the billboard and its place of installation, latitude, longitude data, etc. are displayed. In the billboard setting data 1000, the board surface silhouette image 585 showing the size, angle, etc. of the board surface of billboard which is scheduled to be installed on the billboard installation place photo data 511 and the leg silhouette image 621 of the sign are synthesized and displayed. It is easier to specifically grasp the scenery and situation where the billboard is installed than when only the picture data 511 of the billboard installation place is displayed, and it is possible to provide a billboard installation service such billboard rental which is very useful.

In particular, in the billboard setting data 1000 of this embodiment, not only the board silhouette image 585 but also the leg silhouette image 621 of the billboard are also synthesized on the picture data 511 of the billboard installation place, you can specifically image the billboard with so-called legs. It becomes possible to more specifically recognize the installation place of the billboard by the lower end portion of the leg silhouette image 621. In this respect too, it is possible to provide billboard installation services such as billboard rental which is very useful.

Further, the billboard setting data 1000 according to the present embodiment is not one for each billboard installation place, but a distance from the place of installation of the same billboard is set apart, and the billboard installation data 1000 is a short distance about 20 m away from the billboard installation place, A middle distance that is about 50 m away, a long distance that is about 100 m away, and the like are synthesized with the board surface silhouette image 585 and the leg silhouette image 621, respectively, so that the user desiring to install a billboard it becomes possible to browse multiple billboard setting data 1000 such as short distance, medium distance, long distance, etc. for the same billboard installation place on the display unit of the information processing communication terminal 1, which is also extremely useful billboard installation service such as billboard rental etc can be provided.

### <Effect of the Billboard Installation Data Generation Transmission Application 16a2 and the Information Processing Communication Terminal 1 According to the Embodiment>

As described above, the CPU11 of the information processing communication terminal 1 of the present embodiment sets the billboard installation data generation transmission application 16a2 by running it, the photo data display control means 11b for displaying the photo data stored in the storage section 13 on the touch panel type display section 15. And a silhouette synthesizing and displaying a silhouette image of a board surface 585 which is a silhouette image of the board face of billboard not carrying advertisement contents to be posted on at least the board face of billboard on the picture data displayed on the touch panel type display section 15 image generating and synthesizing means 11c, the photo data displayed on the touch panel type display unit 15 and the board silhouette image 585, and causes the data communication unit 14 to transmit billboard installation data including at least the billboard setting data transmission control unit 11d.

Therefore, in the information processing server 2 that receives and displays billboard installation data from the information processing communication terminal 1 of this embodiment, display billboard setting data 1000 in which the sheet silhouette image 585 and the leg silhouette image 621 are superimposed on the photograph data 511 is displayed on the display section. The state of the actual billboard installation place can be recognized by the picture data 511 together with the board silhouette image 585 synthesized on the photo data 511 and the leg silhouette image 621, the state of the billboard installed at the billboard setting place can be easily and reliably confirmed on the screen.

Further, the information processing communication terminal 1 of the present embodiment is provided with a touch panel type display unit 15, such as a so-called smart phone, a tablet terminal, and the like. The CPU11 functions as the silhouette image generation and display control means 11c and the user touches the contour point of the billboard to be installed at the billboard installation place to generate a board surface silhouette image 585 on the billboard surface of billboard to create a picture in order to superimpose on data and display it on the touch panel type display unit 15, the user can easily generate the board silhouette image 585 on the photo data 511 and combine it into the photo data 511.

In addition, in the information processing communication terminal 1 of the present embodiment, the CPU11 functions as the silhouette image generation/display control means 11c and displays the picture data 511 of the installation place of the billboard displayed on the touch panel type display unit 15. Since the grid line 581 in a grid pattern is controlled so as to be superimposed and displayed at a predetermined pitch, the user can display on the picture data 511 a silhouette image 585 of board surface or a silhouette image of leg portion of the billboard and a leg silhouette. Since it is a reference in the vertical direction or the horizontal direction when generating the image 621, it is possible to easily and surely generate the sheet silhouette image 585 and the leg silhouette image 621 on the photograph data 511 so that the line does not become oblique.

In addition, in the information processing communication terminal 1 of the present embodiment, the CPU11 functions as the silhouette image generating/synthesizing means 11c, and displays on the picture data 511 displayed on the touch panel type display unit 15, when generating the silhouette image 585 or the leg silhouette image 621 which is a silhouette image of the leg portion and synthesizing and displaying the board silhouette image 585 and the leg silhouette image 621 on the photo data 511, In the case where multiple photo data is saved, . . . The silhouette image 585 or leg silhouette image 621 generated by one piece of photograph data is stored and the saved board surface silhouette image 585 and leg silhouette image 621 are read out and reduced or enlarged, and other photograph data Superimposing it on the image data, thereby synthesizing the board surface silhouette image 585 and the leg silhouette image 621 on the photograph data so as to display them.

Therefore, when storing the photo data of the installation place of the billboard in the data storage area, the short distance photograph data photographed from the place close to the installation place photographed with the distance changed for the same installation place and the short distance photograph data when photographing multiple pieces of picture data including at least the long distance photo data photographed from a distant place and storing it in the data storage area, it reads the stored board surface silhouette image 585 and the leg silhouette image 621 and reduces or enlarges it. It is possible to easily generate composite image data obtained by superposing the sheet silhouette image 585 and the leg silhouette image 621 on the photographic data.

In the information processing communication terminal 1 of the above embodiment, the data storage area 16b for storing data such as image data is provided in the storage unit 16 of the information processing communication terminal 1 is not limited to this but may be provided in the memory 13 of the information processing communication terminal 1 or may be provided in a cloud server (not shown) which is a device different from the information processing communication terminal 1 via the Internet 3. Alternatively, it may be arranged such that data such as image data is stored in a device other than the information processing communication terminal 1.

What is claimed is:

1. A billboard installation data generation and transmission program, whereby an information processing communication terminal provided with at least a camera, a data communication unit for transmitting and receiving data, and a display unit, is executed,
as a photo data storage control means for storing photo data of billboard installation places photographed by the camera in a data storage area,
as a photo data display control means for displaying the photo data stored in the data storage area on the display unit,
as a silhouette image generation/combination/display control means for generating, on a piece of photo data displayed on the display unit, a board surface silhouette image which is a silhouette image of the board surface of the billboard which does not carry the advertisement content to be carried thereon, and combining the above-mentioned board surface silhouette image with said piece of photo data, thereby to display the combined image, and as a billboard installation data transmission control means for transmitting, from the above-mentioned data communication unit, a piece of billboard installation data including at least said piece of photo data and said board surface silhouette image displayed on the display unit.

2. The billboard installation data generation and transmission program according to claim 1, wherein the display unit of the information processing communication terminal is a touch panel type display unit, and the silhouette image generating and synthesizing display control means is such that the user touches a contour point of the billboard on said piece of photo data displayed on the display unit, thereby generating the board surface silhouette image, superimposing the board surface silhouette image on said piece of photo data, and displaying the superimposed on the display unit.

3. The billboard installation data generation and transmission program according to claim 1, wherein the silhouette image generating and synthesizing display control means is such that when generating the board surface silhouette image, a set of legs silhouette image that is a silhouette image of leg portions of a billboard is added to the board surface silhouette image, and the combination thereof is superimposed on said piece of photo data displayed on the display unit so that the whole thereof is displayed on the display unit.

4. The billboard installation data generation and transmission program according to claim 1, wherein the silhouette image generating and synthesizing display control means is further such that when generating the board surface silhouette image on said piece of photo data displayed on the display unit, square-shaped grid lines are superimposed at a reference predetermined pitch, and displayed on the display unit.

5. The billboard installation data generation and transmission program according to claim 1, wherein the silhouette image generation/combination/display control means performs control so that when generating the board surface silhouette image on said piece of photo data displayed on the display unit, combining the board surface silhouette image with said piece of photo data and then displaying the combined image, if a plurality of photo data are being stored in the data storage area, a board surface silhouette image generated with one of the photo data is saved, and the saved board surface silhouette image is read out, reduced or enlarged and attached on another piece of photo data, thereby displaying the board surface silhouette image on said piece of photo data in a combined manner.

6. The billboard installation data generation and transmission program according to claim 1, wherein the photo data storage control means performs control such that when storing photo data of billboard installation places photographed by the camera in the data storage area without storing a plurality of photo data obtained by photographing each billboard installation place at different distances, it is impossible to proceed to the process of displaying the photo data stored in the data storage area on the display unit by using the photo data display control means.

7. The information processing communication terminal characterized by executing the billboard installation data generation and transmission program according to claim 1.

8. An information processing communication server comprising: a data receiving means for receiving the billboard installation data received from the information processing communication terminal that executes the billboard installation data generation and transmission program according to claim 7; and a billboard installation service provision means that provides a billboard installation service based on the billboard installation data in such a manner that a plurality of billboard installation data received by the data receiving means are displayed, and simultaneously a billboard installation data selection screen that allows the user to make a selection from among the displayed plurality of billboard installation data, is generated and displayed on its own information processing communication terminal or the user's information processing communication terminal.
